(19) United States
(12) Patent Application Publication
(10) Pub. No.: US 2006/0181785 A1
(43) Pub. Date: Aug. 17, 2006

(54) Optical system, optical pickup apparatus, optical disc reproducing and/or recording apparatus and relay lens

(75) Inventors: Nobuyoshi Mori, Tokyo (JP); Kenji Konno, Osaka (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 11/352,834

(22) Filed: Feb. 13, 2006

(30) Foreign Application Priority Data
Feb. 17, 2005 (JP) JP2005-040627

(51) Int. Cl. G02B 9/00

(52) U.S. Cl. 359/754

(57) ABSTRACT

An optical system is used in an optical pickup apparatus which conducts reproducing and/or recording information for a first optical disk having a thinner protective substrate t1 [mm] and a second optical disk having a thicker protective substrate t2 [mm]. The optical system comprises a relay lens group comprising at least one movable lens group. The movable lens group moves so that for the first optical disk, a parallel or substantial parallel light flux emitted from the relay lens group enters the objective lens while a divergent light flux emitted from the relay lens group enters the objective. The movable lens group satisfies the following formula:
7.5<=(NA1·δ)/(t2−t1)<=22.

### BACKGROUND OF THE INVENTION

The present invention relates to an optical system, an optical pickup apparatus, an optical disc reproducing and/or recording apparatus and a relay lens, and in particular, to an optical system, an optical pickup apparatus, an optical disc reproducing and/or recording apparatus and a relay lens capable of conducting at least one of recording and reproducing of information for different types of optical information recording media compatibly.

With commercial application of a short wavelength red semiconductor laser in the recent years, there has been commercialized DVD (Digital Versatile Disc) representing a high density optical disc that is capable of recording a large amount of information while keeping the same size as that of CD (Compact Disc) representing a conventional optical disc (an optical disc is also called an optical information recording medium).

In recent years, there has been developed a next generation optical disc capable of recording larger amount of information. A light convergence optical system in an optical pickup apparatus employing a medium representing such next generation optical disc is required that a dimension of a diameter of a spot converged on an information recording surface through an objective optical system be small, for the purpose of attaining high density of recording signals and reproduction of high density recorded signals. Therefore, a laser which is a light source is required to have a shorter wavelength. Specifically, commercial application of a blue semiconductor laser having a wavelength of about 400 nm is expected.

As a next generation optical disc so-called a high density optical disc conducting recording and/or reproducing of information by the use of a blue semiconductor laser with wavelength of about 400 nm, there are HD DVD (High Definition DVD: hereinafter referred to as HD) and Blu-ray Disc (hereinafter referred to as BD). Among them, HD is designed to have numerical aperture NA of 0.67, a light source wavelength of 405 nm and a thickness of a protective substrate of 0.6 mm, and it can record information of 15-20 GB per one surface for an optical disc having the same diameter of 12 cm as that of DVD. On the other hand, BD is designed to have numerical aperture NA of 0.85, a light source wavelength of 405 nm and a thickness of a protective substrate of 0.1 mm, and it can record information of 20-30 GB per one surface for an optical disc having a diameter of 12 cm.

In the present stage, however, standards for two types of high density optical discs have been determined, and a sale of software wherein various types of information are recorded for both high density optical discs is expected. Therefore, if an optical pickup apparatus has only ability to conduct recording and/or reproducing of information properly only for one type of high density optical disc, the optical pickup apparatus is extremely inconvenient and it is not exhibiting its function sufficiently from the viewpoint of a consumer.

Therefore, there has been developed an objective optical system for correcting spherical aberration caused by a protective substrate thickness by utilizing wavelength dependency of spherical aberration generated by a diffractive structure, as an objective optical system capable of conducting recording compatibly for optical discs each having a different protective substrate thickness and a different light source wavelength (see Document 1 described later).

Further, as an objective optical system capable of conducting recording of information compatibly for optical discs each having a different protective substrate thickness and the same light source wavelength, there has been developed an objective optical system for correcting spherical aberration caused by a protective substrate thickness by forming, on an optical surface, the ring-shaped zones composed of microscopic steps, and by utilizing that a light-convergence position for the light flux passing through the ring-shaped zones depends on the thickness of the protective substrate (see Document 2 described later).

Document 1: TOKUKAI No. 2001-195769 (Japanese Published Patent Application No. 2001-195769)

Document 2: TOKUKAIHEI No. 11-96585 (Japanese Published Patent Application No. H11-96585)

However, when conducting recording of information for BD and HD compatibly, both of them are different each other in terms of a protective substrate thickness, and are the same each other in terms of a light source wavelength. Therefore, if the objective optical system in the aforesaid Document 1 is applied as it is, it is difficult to correct spherical aberration caused by a protective substrate thickness, by utilizing diffracting actions, for BD and HD, because they are the same in terms of a light source wavelength, which is a problem.

On the other hand, if the objective optical system in the aforesaid Document 2 is applied as it is, it is difficult to correct spherical aberration to the extent to be fit for practical use, for BD and HD where an objective optical system has a high numerical aperture, because an amount of spherical aberration caused by a difference of protective substrate thickness is great, which is a problem.

Further, it is difficult to achieve a compatibility for BD and HD which are the same each other in terms of a light source wavelength, even though a known technology to utilize wavelength dependency of diffracting actions or a technology to use a wavelength selecting filter having wavelength-dependency of transmittance, as a technology to control a numerical aperture of an objective optical system in accordance with a light source wavelength, is applied, because BD and HD are different from each other in terms of a numerical aperture, which is a problem.

The invention has been achieved in view of the aforesaid point, and its object is to provide an optical system, an optical pickup apparatus, an optical disc reproducing and/or recording apparatus and a relay lens capable of conducting properly recording and/or reproducing of information for different high density discs by using a light flux with a short wavelength.

### SUMMARY OF THE INVENTION

According to various embodiments, the present teachings can provide an optical pickup apparatus for conducting reproducing and/or recording information for a first optical disk comprising a first protective substrate whose thickness is t1 [mm] and a second optical disk comprising a second protective substrate whose thickness is t2 [mm] (t1<t2) by using a light flux. The optical pickup apparatus can comprise a light source which emits the light flux and a optical system.

The optical system can comprise a relay lens group and an objective lens which can converge the light flux emitted from the light source and passing through the relay lens group onto an information recording plane of the first optical disk or the second optical disk. The relay lens group can comprise a plurality of lens groups comprising at least one movable lens group which is movable in the direction of an optical axis.

In case that the reproducing and/or recording information for the first optical disk is conducted, a light flux emitted from the relay lens group can enter the objective lens so that a magnification of the objective lens is more than − 1/100 and less than 1/50. In case that the reproducing and/or recording information for the second optical disk is conducted, a light flux emitted from the relay lens group can enter the objective lens as a divergent light.

As for at least one of the movable lens group, in case that the reproducing and/or recording information for the second optical disk is conducted, a moving distance δ [mm] between a position of the movable lens group for reproducing and/or recording information for the first optical disk and a position of the movable lens group for reproducing and/or recording information for the second optical disk can satisfy the following formula:
7.5←(NA1×δ)/(t2−t1)←22,
where NA1 represents a numerical aperture of the objective lens necessary for reproducing and/or recording information for the first optical disk.

### BRIEF DESCRIPTION OF THE DRAWINGS

FIG. 1 is a schematic diagram showing an internal structure of an optical pickup apparatus according to certain embodiments.

FIG. 2 is a cross-sectional view showing an embodiment in the case of using an optical disc having a first protective substrate in the first example.

FIG. 3 is a cross-sectional view showing an embodiment in the case of using an optical disc having a second protective substrate in the first example.

FIG. 4 is a cross-sectional view showing an embodiment in the case of using an optical disc having a first protective substrate in the second example.

FIG. 5 is a cross-sectional view showing an embodiment in the case of using an optical disc having a second protective substrate in the second example.

FIG. 6 is a cross-sectional view showing an embodiment in the case of using an optical disc having a first protective substrate in the third example.

FIG. 7 is a cross-sectional view showing an embodiment in the case of using an optical disc having a second protective substrate in the third example.

FIG. 8 is a cross-sectional view showing an embodiment in the case of using an optical disc having a first protective substrate in the fourth example.

FIG. 9 is a cross-sectional view showing an embodiment in the case of using an optical disc having a second protective substrate in the fourth example.

FIG. 10 is a cross-sectional view showing an embodiment in the case of using an optical disc having a first protective substrate in the fifth example.

FIG. 11 is a cross-sectional view showing an embodiment in the case of using an optical disc having a second protective substrate in the fifth example.

FIG. 12 is a cross-sectional view showing an embodiment in the case of using an optical disc having a first protective substrate in the sixth example.

FIG. 13 is a cross-sectional view showing an embodiment in the case of using an optical disc having a second protective substrate in the sixth example.

FIG. 14 is a cross-sectional view showing an embodiment in the case of using an optical disc having a first protective substrate in the seventh example.

FIG. 15 is a cross-sectional view showing an embodiment in the case of using an optical disc having a second protective substrate in the seventh example.

FIG. 16 is a schematic diagram showing an internal structure of another example of the optical pickup apparatus according to certain embodiments.

### DETAILED DESCRIPTION OF THE PREFERRED EMBODIMENT

The first embodiment of the invention will be described below. An optical system relating to the present embodiment is one provided in an optical pickup apparatus conducting recording and/or reproducing for plural optical discs each being different in terms of a thickness of a protective substrate. The optical system can comprise a relay lens group being composed of plural lens groups in which at least one lens group among the plural lens groups is a movable lens group capable of moving along the optical axis direction, and an objective lens that converges light having a prescribed wavelength emitted from the light source through the relay lens group. When the relay lens group conducts recording or reproducing for the optical disc having a first protective substrate thickness, the relay lens group can emit a light flux that is substantially in parallel or is slightly converged. When the relay lens group conducts recording and/or reproducing for an optical disc having a second thickness of protective substrate which is greater than that of the first protective substrate, the relay lens group can emit a light flux that is divergent to the objective lens and the movable lens group can be moved so that amount of movement δ [mm] from the position of the movable lens group for conducting recording and/or reproducing for an optical disc having the first protective substrate can satisfy the following expression (1);
7.5≦(NA1×δ)/(t2−t1)≦22 (1)
where, NA1 represents a numerical aperture of the objective lens in the case of conducting recording and/or reproducing for the optical disc having the first protective substrate, t1 [mm] represents the first protective substrate thickness and t2 [mm] represents the second protective substrate thickness. Further, the aforesaid phrase “substantially in parallel or is slightly converged” means that the magnification of the objective lens is greater than − 1/100 and smaller than 1/50. Further, if there are plural movable lens group, at least one movable lens group has only to satisfy the expression (1). Further, when conducting reproducing and/or recording for the second optical disc, it is preferable that a light flux can enter the objective lens so that the magnification of the objective lens is not less than −⅕ and not more than − 1/30. More preferable is that the magnification of the objective lens is not less than − 1/10 and not more than − 1/30. Incidentally, it is preferable that the relay lens group includes at least one fixed lens group which does not move in the direction of the optical axis.

Owing to this first embodiment, when using an objective lens whose spherical aberration is corrected under the state where a light flux that is mostly parallel or slightly converged is emitted to an objective lens for the optical disc having the first protective substrate thickness, at least one lens group of relay lens group is moved, and thereby, the working magnification of the objective lens is changed so that divergent light can enter the objective lens, thus, spherical aberration generated on the optical disc having the second protective substrate thickness can be corrected. In that case, by keeping the lower limit value of the aforesaid expression (1), it is possible to reduce aberration generated when the relay lens is decentered, and to generate an excellent spot on a recording surface. Thus, at least one of excellent recording signal and reproducing signal can be obtained. Since an amount of movement of an actuator is generally proportional to a precision of decentering, it is possible to prevent that an amount of movement of a movable lens group becomes too large, and thereby, a load applied on the actuator can be reduced. Thus, downsizing of an apparatus can be achieved together with a reduction of an amount of decentering caused by the movement.

An optical system of the second embodiment of the invention is the optical system of the first embodiment, wherein the first and second protective substrate thicknesses satisfy the following expressions (2) and (3);
0.06≦t1≦0.11 (2)
0.54≦t2≦0.62 (3)

where, t1 represents the first protective substrate thickness and t2 represents the second protective substrate thickness. When the expression (2) is satisfied, the optical system can be suitable for BD and for multi-layer BD. While, when the expression (3) is satisfied, the optical system can be suitable for HD and for multi-layer HD.

An optical system of the third embodiment is the optical system of the first or second embodiment, wherein the relay lens group is arranged successively in the order of the first lens group having negative refractive power and the second lens group having positive refractive power where the first lens group is farther from the objective lens than the second lens group, and when conducting recording and/or reproducing for optical discs each having a different protective substrate thickness, the first lens group is the movable lens group, and amount of movement δ of the first lens group satisfies the following expression (4);
7.5≦(NA1·δ)/(t2−t1)≧22 (4)
where NA1 represents a numerical aperture of the objective lens in the case of conducting recording and/or reproducing for the optical disc having the first protective substrate thickness, t1 represents the first protective substrate thickness and t2 represents the second protective substrate thickness.

Owing to the third embodiment, recording for optical discs each having a different protective substrate thickness can be conducted properly in the simple structure. Also, by keeping the lower limit of the aforesaid expression (4), it is possible to reduce aberration that is caused when the relay lens is decentered, and to generate an excellent spot on a recording surface, which makes it possible to obtain excellent recording signals. Further, if the upper limit of the aforesaid expression (4) is not exceeded, it is possible to prevent an excessive amount of movement of the movable lens, and thereby, to reduce a load applied on an actuator, which makes it possible to attain a reduction of an amount of decentering caused by the movement and to attain downsizing of an apparatus.

Further, by arranging a diaphragm in front of the relay lens group's surface opposite to and farthest from the objective lens subject to satisfying the expression (4), it is possible to make a light-flux obtaining a necessary numerical aperture of the objective lens enter the objective lens, without providing an aperture regulating member.

An optical system of the fourth embodiment is the optical system of the third embodiment, wherein the first lens group is composed only of a single lens having negative refractive power, and the relay lens group satisfies the following expressions (5);
−3.5≦p1/p2≦−1.8 (5)

where, p1 represents the refractive power of the first lens group and p2 represents the refractive power of the second lens group.

Owing to the fourth embodiment, when the movable lens group composed of a single lens having a negative refractive index is subjected to weight reduction and thereby, a load applied on the actuator for movement is reduced. Thus, downsizing of the actuator is made possible, which makes it possible to downsize an optical system and a driving apparatus for optical discs. It is further possible to reduce decentering sensitiveness and to prevent an excessive amount of movement of the lens group.

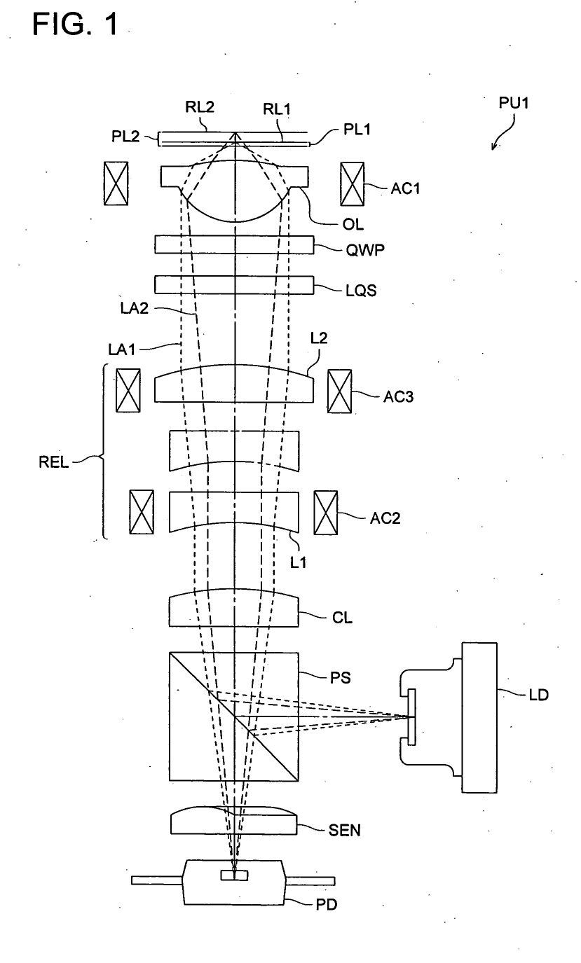

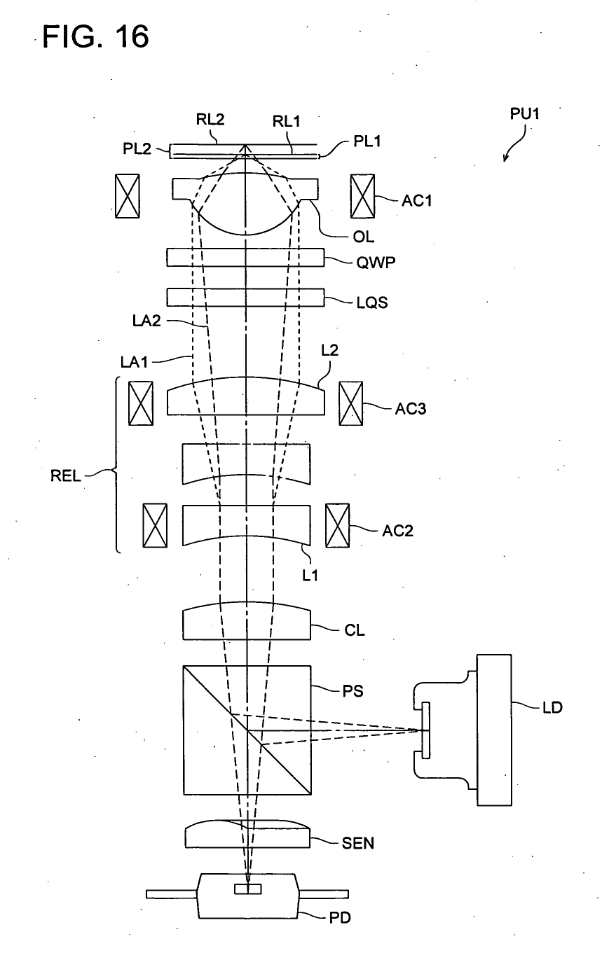

Further, by satisfying the aforesaid expressions (4) and (5), it is possible to make first and second entrance pupil diameters (for example, an entrance pupil diameter for L1 in the example shown in FIG. 1), in which the relay lens group and the objective lens are combined. (The first entrance pupil diameter is entrance pupil diameter for obtaining necessary numerical apertures NA1 of the objective lens which is needed to conduct recording for optical discs having the first protective substrate thickness. The second entrance pupil diameter is entrance pupil diameter for obtaining necessary numerical apertures NA2 of the objective lens which is needed to conduct recording for optical discs having the second protective substrate thickness.) Thereby, it is possible to guide a semiconductor laser emitted and collimated by a collimator to a recording surface without big loss. Therefore, it is possible to obtain the optical system having high efficiency of using light. Incidentally, the phrase “substantially the same” mentioned here means that r2 is greater than 80% of r1 and is smaller than 120% of r1 when r1 represents an entrance pupil diameter for NA1 and r2 represents an entrance pupil diameter for NA2. Preferable is that r2 is greater than 90% of r1 and is smaller than 110% of r1. More preferable is that r2 is greater than 95% of r1 and is smaller than 105% of r1. Most preferable is that r2 is the same as ri as shown in FIG. 16.

An optical system of the fifth embodiment is the optical system of the third or fourth embodiment, wherein the second lens group is composed of a single lens whose one surface facing the objective lens is formed to be convex owing to the fifth embodiment, when a distance from the first lens group to the second lens group in the relay lens group is shortened, and refractive power of each lens group is made to be smaller, it is possible to reduce aberration generated on the relay lens group, and thereby to restrain deterioration by aberration caused by decentering.

An optical system of to the sixth embodiment is the optical system of each of the third-fifth embodiments, wherein numerical aperture NA1 of the objective lens is 0.8 or more, and the relay lens group comprises a lens made of plastic whose water absorption is 0.1% or less. Owing to the sixth embodiment, downsizing of an actuator can be attained by achieving weight reduction of a relay lens group. In addition, an inhibition of aberration caused by fluctuations in water absorption resulting from ambient humidity changes of plastic can be achieved, and excellent recording operations can be carried out even in the case of high density optical discs employing a high numerical aperture of NA 0.8 or more.

An optical system of to the seventh embodiment is the optical system of the sixth embodiment, wherein the second lens group is composed of a single lens made of plastic whose water absorption is 0.1% or less. Owing to the seventh embodiment, it is possible to attain weight reduction and reduction of manufacturing cost for apparatuses, by making the second lens group arranged to be closest to the object side in the relay lens group to be a single lens made of plastic. Further, a marginal light height of the lens arranged to be closest to the objective lens side in the relay lens group is great, namely, a diameter of the light flux is large. Therefore, the lens is easily affected by refractive index changes caused by moisture absorption of plastic resulting from ambient humidity changes and by distribution of refractive index. However, it is possible to lighten these influences sufficiently, by using a lens made of plastic whose water absorption is 0.1% or less.

An optical system of the eighth embodiment is the optical system of the seventh embodiment, wherein the second lens group is capable of moving in the direction perpendicular to the optical axis direction. Owing to the eighth embodiment, coma generated in the course of tracking of the objective lens can be reduced by composing the second lens group so that it can move in the direction perpendicular to the optical axis direction.

An optical system of the ninth embodiment is the optical system of the first or second embodiment, wherein the relay lens groups are arranged in the order of the first lens group having positive refractive power, the second lens group having negative refractive power and the third lens group having positive refractive power, where the first lens group is farthest from the objective lens, and when conducting recording and/or reproducing for optical discs each having a different protective substrate thickness, the first lens group and the second lens group can move as the movable lens group, and amount of movement δ [mm] of the second lens group satisfies the following expression (6);
8≦(NA1·δ)/(t2−t1)≦15 (6)
where NA1 represents a numerical aperture of the objective lens in the case of conducting recording and/or reproducing for the optical disc having the first protective substrate thickness, t1 represents the first protective substrate thickness and t2 represents the second protective substrate thickness. Incidentally, if the second lens group satisfies the conditional expression (6), the first lens group may satisfy the expression (1) or (6), or need not satisfy.

Owing to the ninth embodiment, it is possible to equalize substantially the entrance pupil diameters for both of an optical disc having the first protective substrate thickness and an optical disc having the second protective substrate thickness in the system where a relay lens and an objective lens are combined with an amount of movement that is smaller compared with a relay lens of a two-lens-groups structure. By keeping the lower limit of the aforesaid expression (6), it is possible to prevent an excessive amount of fluctuations of aberration caused by decentering of the relay lens group.

Further, by keeping the upper limit value not to be exceeded, it is possible to reduce an amount of movement of a movable lens group and thereby, to reduce a load applied on an actuator.

An optical system of the tenth embodiment is the optical system of the ninth embodiment, wherein the relay lens group satisfies the following expressions (7) and (8);
0.7≦p1/p3≦1.6 (7)
−5≦p2/p3<−3.7 (8)

where, p1 represents refractive power of the first lens group, p2 represents refractive power of the second lens group and p3 represents refractive power of the third lens group.

The tenth embodiment makes it possible to realize the structure of the ninth embodiment by a simple structure. By keeping the lower limit of the aforesaid expression (7), it is possible to prevent an excessive amount of movement of the relay lens group, and to maintain the entrance pupil diameter in the combined system to be constant. On the other hand, by keeping the upper limit value of the expression (7) not to be exceeded, it is possible to correct various aberrations properly and to restrain occurrence of aberration caused by decentering of the first lens group. Further, by keeping the lower limit of the aforesaid conditional expression (8), it is possible to correct various aberrations properly, and to restrain occurrence of aberration caused by decentering of the first lens group. By keeping the upper limit value of the expression (8) not to be exceeded, it is possible to prevent an excessive amount of movement of the relay lens group, and to lighten a load applied on an actuator.

An optical system of the eleventh embodiment is the optical system of the ninth or tenth embodiment, wherein the third lens group is composed of a single lens whose one surface facing the objective lens is formed to be convex. The eleventh embodiment makes it possible to correct various aberrations properly with less number of lenses and to reduce the total length of the relay lens group.

An optical system of the twelfth embodiment is the optical system of the ninth eleventh embodiments, wherein the second lens group is composed of a single lens whose one side opposite to the side facing the objective lens is formed to be concave. The twelfth embodiment makes it possible to restrain occurrence of aberration caused by decentering, and to reduce an amount of movement of the lens.

An optical system of the thirteenth embodiment is the optical system of the ninth-twelfth embodiment, wherein numerical aperture NA1 of the objective lens is 0.8 or more, and the relay lens group comprises a lens that is made of plastic whose water absorption is 0.1% or less.

In the thirteenth embodiment, downsizing of an actuator can be realized because the relay lens group is light in weight. In addition, aberration caused by fluctuations in water absorption resulting from ambient humidity changes of plastic can be reduced, and excellent recording operations can be carried out even in the case of high density optical discs employing a high numerical aperture of NA 0.8 or more.

An optical system of the fourteenth embodiment is the optical system of the thirteenth embodiment, wherein the third lens group is composed of a single lens made of plastic whose water absorption is 0.1% or less. Owing to the fourteenth embodiment, it is possible to achieve the weight reduction and reduction of manufacturing cost for an apparatus, by making the third lens group arranged to be closest to an object side in the relay lens group a plastic single lens. Further, a marginal light height of the lens arranged to be closest to the objective lens side in the relay lens group is great, namely, a diameter of the light flux is large. Therefore, the lens is easily affected by refractive index changes caused by moisture absorption of plastic resulting from ambient changes and by distribution of refractive index. However, it is possible to lighten these influences sufficiently, by using a lens made of plastic whose water absorption is 0.1% or less.

An optical system of the fifteenth embodiment is the optical system of the first or second embodiment, wherein the following expression (9) is satisfied;
0.95≦NA1·TF1/(NA2·TF2)≦1.05 (9)

where TF1 represents a combined focal length of the relay lens group and the objective lens in the case of conducting recording and/or reproducing for the optical disc having the first protective substrate thickness, NA1 represents a numerical aperture of the objective lens in the case of conducting recording and/or reproducing for the optical disc having the first protective substrate thickness, TF2 represents a combined focal length of the relay lens group and the objective lens in the case of conducting recording and/or reproducing for the optical disc having the second protective substrate thickness and NA2 represents a numerical aperture of the objective lens in the case of conducting recording and/or reproducing for the optical disc having the second protective substrate thickness. Owing to the fifteenth embodiment, by designing the optical system so that the aforesaid expression (9) is satisfied, it is possible to equalize substantially the entrance pupil diameters in the system where a relay lens group and an objective lens are combined, and thereby, to obtain the optical system having high efficiency of using light.

An optical system of the sixteenth embodiment is the optical system of the first or second embodiment wherein, when a magnification of the objective lens is finite, namely, the divergent light or the convergent light enters the objective lens, the lens group arranged near the objective lens among lens groups constituting the relay lens group can move in the direction opposite to that for the objective lens and in the direction perpendicular to the optical axis direction owing to the sixteenth embodiment, even when coma is generated in the course of tracking of the objective lens, it is possible to correct coma properly.

An optical system of the seventeenth embodiment is the optical system of the sixteenth embodiment wherein, when conducting recording and/or reproducing for the optical disc having the first protective substrate thickness, a magnification of the objective lens is made to be substantially zero, while when conducting recording and/or reproducing for the optical disc having the second protective substrate thickness, a magnification of the objective lens is made to be negative finite value, and the objective lens is moved in the direction perpendicular to the optical axis, and the lens group arranged in the vicinity of the objective lens among lens groups constituting the relay lens groups is moved in the direction opposite to that of the objective lens. Owing to the seventeenth embodiment, when using an optical disc having the first protective substrate thickness that is affected most by errors, occurrence of aberration is prevented by tracking of the objective lens, and when using an optical disc having the second protective substrate thickness, the relay lens group is moved in the direction opposite to that for tracking movement of the objective lens to correct properly the coma caused by tracking of the objective lens.

An optical system of the eighteenth embodiment is the optical system of the first or second embodiment wherein, the following expression (10) is satisfied;
0.6≦TO/TR≦1.5 (10)

where, TO represents an absolute value of an amount of movement of the objective lens in the direction perpendicular to the optical axis in the case of tracking of the objective lens and TR represents an absolute value of an amount of movement of the relay lens group in the direction perpendicular to the optical axis of the relay lens group. The eighteenth embodiment makes it possible to correct properly coma caused by tracking. By keeping the lower limit of the expression (10), it is possible to prevent excessive correction of coma, and to realize reduction of residual aberration. When the upper limit of the expression (10) is kept not to be exceeded, it is possible to prevent insufficient correction of coma.

An optical system of the nineteenth embodiment is the optical system of the sixteenth-eighteenth embodiments:, wherein the lens group arranged to be closest to the objective lens among the relay lens groups is composed of a lens made of plastic whose water absorption is 0.1% or less and specific gravity is 1.5 or less in the relay lens groups. Owing to the nineteenth embodiment, weight reduction and reduction of manufacturing cost for relay lens groups can be attained, and thereby, a load to be applied on an actuator for moving a relay lens group for correcting coma generated by tracking can be lightened, and the relay lens group can be moved at high speed to follow the objective lens. Further, in the relay lens group, a marginal light height of the lens arranged to be closest to the objective lens side is great, namely, a diameter of the light flux is large. Therefore, the lens is easily affected by refractive index changes caused by moisture absorption of plastic resulting from ambient changes and by distribution of refractive index. However, it is possible to lighten these influences sufficiently, by using a lens made of plastic whose water absorption is 0.1% or less.

An optical system relating of the twentieth embodiment is the optical system of the first or second embodiment wherein, the objective lens is composed of two lenses. Owing to the twentieth embodiment, by employing a two-lens-groups structure for the objective lens, the number of lens surfaces is increased and the degree of freedom for design is increased, thus, an amount of generation of aberration on each lens surface can be reduced, by dispersing an amount of refraction of a light flux on each lens surface. Further, since spherical aberration is fluctuated by the change of working magnification of the objective lens, it is possible to correct spherical aberration for optical discs each having a different protective substrate thickness. However, when a numerical aperture of the objective lens is greater, spherical aberration of 5^{th} order or more which cannot be corrected by the change of the working magnification is generated. Therefore, by employing the two-lens-groups structure for the objective lens, generation of the aberration on each surface can be restrained, and an excellent spot can be generated on a recording surface.

An optical system of the twenty-first embodiment is the optical system of the twentieth embodiment wherein, the lens arranged to be farther from the optical disc among two lenses constituting the objective lens has a phase structure. Owing to the twenty-first embodiment, when conducting recording and/or reproducing operations for optical discs each employing a different wavelength, it is possible to differentiate operations of the phase structure depending on the wavelength, and thereby, to correct aberration properly even for more types of optical discs. Incidentally, “the phase structure” in this case includes a structure for providing a phase difference including a diffractive structure and a structure for providing an optical path difference.

An optical system of the twenty-second embodiment is the optical system of the twentieth or twenty-first embodiment wherein, the following expression (11) is satisfied;
0.05≦PO1/PO2<0.2 (11)

where, PO1 represents refractive power of the lens arranged to be closer to the relay lens group where the lens is among the lenses of the objective lens, and PO2 represents refractive power of the lens arranged to be farther from the relay lens group where the lens is among the lenses of the objective lens. Owing to the twenty-second embodiment, generation of the high order spherical aberration mentioned above can be restrained. Further, by keeping the lower limit of the expression (11), generation of high order spherical aberration can be restrained. By keeping the upper limit of the expression (11) not to be exceeded, it is possible to increase a working distance of the objective lens, namely, a distance from the surface of the objective lens closest to the disc side to the surface of the disc.

The twenty-third-embodiment is a driving apparatus for an optical disc that comprises the optical system in any one of the first-twenty-second embodiments, a light source emitting light having prescribed wavelength and a light-receiving element.

The twenty-fourth embodiment is a relay lens that is used for the optical system in any one of the first-twenty-second embodiments.

Then, the preferable twenty-fifth embodiment will be shown below.

An optical system used for an optical pickup apparatus conducting reproducing and/or recording of information by using a light flux emitted from a light source for the first optical disc having the first protective substrate whose thickness is t1 [mm] and for the second optical disc having the second protective substrate whose thickness is t2 [mm] (t1<t2), wherein the optical system comprises a relay lens group having plural lens group including at least one movable lens group capable of moving in the optical axis direction, and an objective lens for converging the light flux emitted from the light source on an information recording surface of the first optical disc or the second optical disc, and the relay lens group emits a light flux so that the magnification of the objective lens is greater than − 1/00 and smaller than 1/50 when conducting reproducing and/or recording for the first optical disc and emits a divergent light to the objective lens when conducting reproducing and/or recording for the second optical disc, and amount of movement δ [mm] from apposition of the movable lens group in the case of conducting reproducing and/or recording for the first optical disc to a position of the movable lens group in the case of conducting reproducing and/or recording for the second optical disc satisfies the following expression, concerning at least one movable lens group;
7.5≦(NA1·δ)/(t2−t1)≦22

where, NA1 represents a numerical aperture of the objective lens in the case of conducting reproducing and/or recording for the first optical disc.

In the twenty-fifth embodiment, when the relay lens group has plural movable lens groups, at least one movable lens group has only to satisfy the aforesaid expression. Further, in the twenty-fifth embodiment, when conducting reproducing and/or recording for the first optical disc, it is preferable that the magnification of the objective lens is 0, namely, that a parallel light enters the objective lens. It is further preferable that a lens group arranged next to the objective lens and arranged on the light source side is a relay lens group, in the optical path of the optical pickup apparatus. Further, when conducting reproducing and/or recording for the second optical disc, it is preferable that a light flux enters the optical lens so that the magnification of the objective lens is not less than −⅕ and is not larger than − 1/30. More preferable is that the magnification of the objective lens is not less than − 1/10 and not more than − 1/30. Incidentally, it is preferable that the relay lens group comprises at least one fixed lens group which does not move in the direction of the optical axis.

In the twenty-fifth embodiment, when using BD as the first optical disc and using HD or DVD as the second optical disc, it is preferable that the following expression is, satisfied.
0.06 [mm]≦t1≦0.11 [mm]
0.54 [mm]≦t2≦0.62 [mm].

The twenty-sixth embodiment is the optical system of the twenty-fifth embodiment wherein the relay lens group has plural lens groups, and the plural lens groups are composed of positive second lens group and negative first lens group in this order from the objective lens side, and the first lens group is a movable lens group. Incidentally, in the twenty-sixth embodiment, if the first lens group is composed only of a single lens having negative refractive power, it is preferable that the relay lens group satisfies the following expression;
−3.5<p1/p2≦−1.8

where, p1 represents refractive power of the first lens group and p2 represents refractive power of the second lens group.

In the twenty-sixth embodiment, it is also one of the preferable embodiments that the second lens group is composed of a single lens, the single lens has the first optical surface on the first lens group side and the second optical surface on the objective lens side, and the second optical surface is a convex surface. Further, in the twenty-sixth embodiment, it is preferable that the relay lens group includes a lens made by plastic having water absorption of 0.1% or less, when numerical aperture NA1 of the objective lens is 0.8 or more. In particular, it is preferable that the second lens group is a single lens made by plastic whose water absorption is 0.1% or less. It is further preferable that the second lens group is movable in the direction perpendicular to the optical axis direction.

The twenty-seventh embodiment is the optical system of the twenty-fifth embodiment wherein the relay lens group comprises plural lens groups, and the plural lens groups are composed of positive third lens group, negative second lens group and positive first lens group in this order from the objective lens side, and the first lens group and the second lens group are movable lens groups. Incidentally, in the present embodiment, it is preferable that the second lens group satisfies the expression of the twenty-fifth embodiment, and the first lens group may either satisfy or not satisfy the expression of the twenty-fifth embodiment. It is further preferable that an amount of movement of the second lens group is greater than that of the first lens group.

Further, in the twenty-seventh embodiment, it is preferable that amount of movement δ [mm] from the position of the second lens group in the case of conducting reproducing and/or recording for the first optical disc to the position of the second lens group in the case of conducting reproducing and/or recording for the second optical disc satisfies the following expression. The first lens group may either satisfy or not satisfy the following expression. Further, an amount of movement of the second lens group is preferably greater than that of the first lens group.
8≦(NA1·δ)/(t2−t1)≦15

Further, in the twenty-seventh embodiment, the relay lens group preferably satisfies the following expression;
0.7≦p1/p3≦1.6
−5≦p2/p3≦−3.7

where, p1 represents refractive power of the first lens group, p2 represents refractive power of the second lens group and p3 represents refractive power of the third lens group.

In addition, in the twenty-seventh embodiment, if the third lens group is composed of a single lens, it is preferable that the single lens has the first optical surface on the second lens group side and the second optical surface on the objective lens side, and the second optical surface is a convex surface. If the second lens group is composed of a single lens, it is preferable that the single lens has the first optical surface on the first lens group side and the second optical surface on the third lens group side, and the first optical surface is a concave surface. Further, it is preferable that the relay lens group includes a lens made by plastic having water absorption of 0.1% or less, when numerical aperture. NA1 of the objective lens is 0.8 or more. More preferable is that the third lens group is composed of a single lens made of plastic whose water absorption is 0.1% or less.

The twenty-eighth embodiment is the optical system of the twenty-fifth embodiment wherein the following expression is satisfied;
0.95≦NA1·TF1/(NA2·TF2)≦1.05

where, TF1 represents a combined focal length of the relay lens group and the objective lens in the case of conducting recording or reproducing for the first optical disc, TF2 represents a combined focal length of the relay lens group and the objective lens in the case of conducting recording or reproducing for the second optical disc, and NA2 represents a numerical aperture of the objective lens in the case of conducting recording or reproducing for the second optical disc.

The twenty-ninth embodiment is the optical system of the twenty-fifth embodiment wherein a lens group arranged closer to the objective lens among lens groups constituting the relay lens group is capable and in the direction opposite to that of the objective lens moving in the direction perpendicular to the optical axis direction, when divergent light or convergent light enters the objective lens. More preferable in the twenty-ninth embodiment is that a parallel light or a substantially parallel light enters the objective lens when conducting recording or reproducing for the first optical disc, and a divergent light enters the objective lens when conducting recording or reproducing for the second optical disc. The substantially parallel light mentioned here means that the magnification of the objective lens is greater than − 1/100 and smaller than 1/50.

The thirtieth embodiment is the optical system of the twenty-fifth embodiment wherein the following expression is satisfied;

ti 0.6≦TO/TR≦1.5

where, TO represents an absolute value of an amount of movement in the direction perpendicular to the optical axis direction in the case of tracking of the objective lens, and TR represents an absolute value of an amount of movement in the direction perpendicular to the optical axis direction of at least one lens group of the relay lens.

Incidentally, in the twenty-ninth embodiment, it is preferable that a lens group arranged to be closest to the objective lens in the relay lens is composed of a lens made of plastic whose water absorption is 0.1% or less and specific gravity is 1.5 or less.

The thirtieth embodiment is the optical system of the twenty-fifth embodiment wherein the objective lens is composed of two lenses. In the present embodiment, it is preferable that the lens arranged to be farther from the optical disc among the two lenses constituting the objective lens has a phase structure. “The phase structure” mentioned here includes a phase difference providing structure (e.g., a diffractive structure and so on) and an optical path difference providing structure. Further, in the thirtieth embodiment, the following expression is preferably satisfied;
0.05≦PO1/PO2<−0.2

where, PO1 represents refractive power of the lens arranged to be closer to the relay lens group among the two lenses constituting the objective lens, while, PO2 represents refractive power of the lens arranged to be farther from the relay lens group among the two lenses constituting the objective lens.

The thirty-first embodiment is the optical system of the twenty-fifth embodiment wherein the optical system has a collimator lens, and the collimator lens is arranged at a position which is in an optical path of the light flux and farther from the objective lens than the relay lens group. In other words, it is preferable that the relay lens group is provided between the collimator lens and the objective lens in the optical path as shown in FIG. 1. Incidentally, “the collimator lens” mentioned here means a fixed lens or a fixed lens group which converts a light flux entering therein into a parallel light flux, and emits the parallel light flux.

The thirty-second embodiment is the optical system of the twenty-fifth embodiment wherein the optical system conducts reproducing and/or recording for the first optical disc and the second optical disc by using the same light flux. For example, the thirty-second embodiment includes a combination in which BD is the first optical disc and HD DVD is the second optical disc.

The thirty-third embodiment is the optical system of the twenty-fifth embodiment wherein the optical system conducts reproducing and/or recording for the first optical disc and the second optical disc by using different light fluxes each having a different wavelength. For example, the thirty third embodiment includes a combination wherein the first optical disc is BD and the second optical disc is DVD, a combination wherein the first optical disc is BD and the second optical disc is CD, and a combination wherein the first optical disc is HD and the second optical disc is CD.

The thirty-fourth embodiment is the optical system of the twenty-fifth embodiment wherein the following expression is satisfied;
r1×0.8<r2<r1×1.2

where, r1 represents an entrance pupil diameter of a relay lens group in the case of conducting reproducing and/or recording for the first optical disc and r2 represents an entrance pupil diameter of a relay lens group in the case of conducting reproducing and/or recording for the second optical disc. Preferable is to satisfy r1×0.9<r2<r1×1.1. More preferable is to satisfy r1×0.95<r2<r1×1.05, and most preferable is to satisfy r2=r1.

The preferable thirty-fifth embodiment is an optical system comprising the optical system of any of twenty-fifth to thirty-fourth embodiments and a light source that emits a light flux.

The preferable thirty-sixth embodiment is an optical disc recording and/or reproducing apparatus comprising the optical pickup apparatus of the thirty-fifth embodiment.

The preferable thirty-seventh embodiment is a relay lens group which can be used for any optical system of twenty-fifth to thirty-fourth embodiments.

Incidentally, “the objective lens” mentioned in the present specification means an optical system which is arranged at a position facing an optical disc in an optical pickup apparatus to have a function to converge a light flux emitted from the light source on an information recording surface of the optical disc, and is movable by an actuator at least in the optical axis direction. “The objective lens” mentioned in the present specification may either be a single lens or be composed of a plurality of lenses. Let it be assumed that the objective lens is not included in the relay lens group in the present specification.

In the present specification, numerical aperture NA of the objective lens on the optical disc side (on the image side) means numerical aperture NA of the optical surface of the objective lens closest to the optical disc side, when the objective lens has plural lenses. Further, a numerical aperture (NA) or a necessary numerical aperture in the present specification means a numerical aperture prescribed by standards of each optical disc, or a numerical aperture of an objective optical system having diffractive marginal ability that is capable of obtaining a spot diameter necessary for conducting recording or reproducing of information in accordance with a wavelength of a working light source for each optical disc.

The lens group mentioned in the present specification means a single lens or plural lenses which are in contact with each other in the case of a fixed lens group, and it means a single lens capable of moving in the optical axis direction or plural lenses which conduct the same movement in the optical axis direction in the case of a movable lens group.

Meanwhile, as optical discs in the present specification, there are given a high density optical information recording medium (high density optical disc), DVD and CD, to which, however, the optical discs are not limited to them. With respect to recording density, recording density of the high density optical disc is highest, then, that of DVD is lower and that of CD is the lowest among the three optical discs.

As a high density optical information recording medium (high density optical disc), there is given an optical disc (which is also called an optical information recording medium) employing a blue semiconductor laser or a blue SHG laser as a light source for conducting recording or reproducing of information, and for example, there are included an optical disc (for example, BD) having protective substrate thickness of about 0.1 mm on which information is recorded by an objective optical system having NA of 0.85 and an optical disc (for example, HD) having protective substrate thickness of about 0.6 mm on which information is recorded by an objective optical system having NA in a range from 0.65 to 0.67. The high density optical disc includes Blu-ray disc (BD) and HD DVD (HD) naturally, a magneto-optical disc, an optical disc having a several—several tens nanometers-thick protective film on an information recording surface and an optical disc having a protective substrate or a protective film whose thickness is zero.

DVD is a generic name of an optical disc in DVD series such as DVD-ROM, DVD-Video, DVD-Audio, DVD-RAM, DVD-R, DVD-RW, DVD+R and DVD+RW, while, CD is a generic name of an optical disc in CD series such as CD-ROM, CD-Audio, CD-Video, CD-R, and CD-RW.

Preferred embodiments for practicing the present invention will be explained as follows, referring to the drawings. In the embodiment described below, there are given various restrictions which are preferable technically for practicing the invention. However, the scope of the invention is not limited to the following embodiment and illustrations.

First, an optical system and an optical pickup apparatus in the present embodiment will be explained, referring to FIG. 1 and FIG. 16. Though BD is used as the first optical disc and HD is used as the second optical disc in the present embodiment, the invention is not limited to that combination.

As shown in FIG. 1 and FIG. 16, optical pickup apparatus PU1 in the present embodiment is provided with blue semiconductor laser LD representing a light source that emits a blue laser light flux with wavelength 405 nm when conducting recording or reproducing of information for BD and HD. In other words, the same light source is used for different discs in the present embodiment.

In the optical axis direction of blue light emitted from the blue semiconductor laser LD, there is provided splitter PS which is substantially in a square shape. In the optical axis direction of light subjected to spectroscopic operation by this splitter PS, there are arranged collimator CL, relay lens group REL composed of the first lens group L1 and second lens group L2, liquid crystal shutter LQS, quarter wavelength plate QWP and objective lens OL in succession, and BD or HD representing an optical information recording medium is arranged at the position facing the quarter wavelength plate QWP through the objective lens OL.

In this case, second lens group L2 is composed of a single lens whose one surface facing the objective lens is formed to be convex substantially. The single lens constituting the second lens group L2 is made of plastic whose water absorption is 0.1% or less and specific gravity is 1.5 or less, and it has positive refractive power.

The first lens group L1 has negative refractive power, and refractive power p₁ of the first lens group L1 and refractive power p₂ of the second lens group L2 satisfy the following expression (5).
−3.5≦p₁/p₂≦−1.8 (5)

Thickness t₁ of the protective substrate of BD in the present embodiment satisfies the following expression (2).
0.06 [mm]≦t₁≦0.11 [mm] (2)

Further, thickness t₂ of the protective substrate of HD in the present embodiment satisfies the following expression (3).
0.54 [mm]≦t₂≦0.62 [mm] (3)

On the other hand, on the side facing the collimator CL through the splitter PS, there are arranged sensor lens SEN that adds astigmatism to the light flux reflected on information recording surface RL1 and photodetector PD for BD and HD for detecting a reflected light flux.

Though blue semiconductor laser LD is used as a light source in the present embodiment, the invention is not limited to this in particular provided that the light source can emit desired light with a short wavelength, and a blue SHG laser, for example, can be used.

Further, the first lens group L1 and the second lens group L2 in the aforesaid relay lens group REL are provided respectively with uniaxial actuators AC2 and AC3, and when recording or reproducing on BD, a distance between the first lens group L1 and the second lens group L2 is optimized by the uniaxial actuator AC2 so that a parallel light flux can emerge.

On the other hand, when recording or reproducing on HD, a distance between the first lens group L1 and the second lens group L2 is optimized by the uniaxial actuator AC2 so that a distance between the first lens group L1 and the second lens group L2 can be smaller than the distance in the *case of conducting recording or reproducing on BD so that a divergent light flux can emerge.

In this case, combined focal length TF₁ of the relay lens group REL and objective lens OL in the case of conducting recording or reproducing for BD, numerical aperture NA₁ of the objective lens OL, combined focal length TF₂ of the relay lens group REL and objective lens OL in the case of conducting recording or reproducing for HD and numerical aperture NA₂ of the objective lens OL satisfy the following conditional expression (9).
0.95≦NA₁·TF₁/(NA₂·TF₂)≦1.05 (9)

Further, in the case of conducting recording or reproducing for HD, when tracking the second lens group L2 by uniaxial actuator AC3 in the direction perpendicular to the optical axis direction, the second lens group L2 is moved in the direction opposite to that for the objective lens OL.

In this case, absolute value TO of an amount of movement of the objective lens in the direction perpendicular to the optical axis in the case of tracking of objective lens OL and absolute value TR of an amount of movement of the relay lens group in the direction perpendicular to the optical axis of relay lens group REL satisfy the following expression (10).
0.6<TO/TR≦1.5 (10)

Further, the uniaxial actuators AC2 and AC3 mentioned above can cope even with BD capable of recording for multiple layers. More specifically, an arrangement is made to be capable of correcting spherical aberration that is caused when conducting the so-called focus-jump; the focus-jump means displacing objective lens OL in the optical axis d direction, by optimizing a distance between first lens group L1 and second lens group L2 by an uniaxial actuator, namely, by changing magnification of the objective lens OL, to get access to information recording layers each being different in terms of depth in the same BD.

In this case, numerical aperture NA1 of objective lens OL in the case of conducting recording for BD is 0.8 or more, and amount of movement δ of the first lens group L1 that moves in accordance with recording operations satisfies the following conditional expression (4);
7.5≦(NA₁·δ)/(t₂−t₁)≦22 (4)

where, t₁ represents a protective substrate thickness of BD, and t₂ represents a protective substrate thickness of HD.

Incidentally, it is also possible to arrange to cope with HD capable of recording for multiple layers by using the aforesaid uniaxial actuators AC2 and AC3, in the same way as in BD. In this case, optical pickup apparatus PU1 is equipped with a recording layer discriminating means for discriminating an information recording layer on which a focal point of the objective lens OL is.

The optical pickup apparatus PU1 is further equipped with a control means that discriminates a type of an optical disc (for example, BD or HD) loaded on a disc tray (not shown in the figures), and moves the first lens group L1 to the optimum position.

Meanwhile, the relay lens group REL in the present embodiment is of the two-lens-groups structure wherein the first lens group L1 and the second lens group L2 are arranged in the order where the first lens group L1 is farther from the objective lens OL than the second lens group L2 is. However, the invention is not limited to this especially, and it is also possible to employ, for example, a three-lens-groups structure wherein a third lens group having positive refractive power is added to be arranged at a position facing the second lens group L2 through the first lens group L1. In this case, a uniaxial actuator is also provided on the third lens group in the same way as in the first lens group L1 and the second lens group L2, to optimize a distance between the third lens group and the adjacent first lens group.

In the case of the relay lens group of the aforesaid three-lens-groups structure, the second lens group L2 is composed of a single lens whose one surface that is opposite to the surface facing the objective lens is formed to be substantially concave, and the third lens group is composed of a single lens whose one surface on the side facing the objective lens is formed to be substantially convex. The single lens constituting the third lens group is made by plastic whose water absorption is 0.1% or less and specific gravity is 1.5 or less.

Refractive power p₃ of the third lens group L3, refractive power p₁ of the first lens group L1 and refractive power p₂ of the second lens group L2 satisfy the following expressions (7) and (8).
0/7≦p₁/p₃≦1.6 (7)
−5≦p₂/p₃≦−3.7 (8)

Further, numerical aperture NA1 of the objective lens OL in the case of conducting recording or reproducing on BD is 0.8 or more, and amount of movement δ of the first lens group L1 that moves in accordance with recording operations satisfies the following expression (6);
8≦(NA₁·δ)/(t₂−t₁)≦15 (6)
where, t₁ represents a protective substrate thickness of BD, and t₂ represents a protective substrate thickness of HD.

In the same way as in the aforesaid relay lens group REL of the two-lens-groups structure, combined focal length TF₁ of the relay lens group REL and the objective lens OL in the case of conducting recording or reproducing on BD, numerical aperture NA₁ of the objective lens OL, combined focal length TF₂ of the relay lens group REL and the objective lens OL in the case of conducting recording or reproducing on HD and numerical aperture NA₂ of the objective lens OL satisfy the following conditional expression (9).
0.95≦NA₁·TF₁/(NA₂·TF₂)≦1.05 (9)

In the same way as in the aforesaid relay lens group REL of the two-lens-groups structure, absolute value TO of an amount of movement of the objective lens in the direction perpendicular to the optical axis in the case of tracking of objective lens OL and absolute value TR of an amount of movement of the relay lens group in the direction perpendicular to the optical axis of relay lens group REL satisfy the following expression (10).
0.6≦TO/TR≦1.5 (10)

Incidentally, the optical pickup apparatus PU1 stated above can be incorporated in an optical disc driving apparatus.

Next, actions of an optical system and of optical pickup apparatus PU1 will be explained.

The optical system and optical pickup apparatus PU1 in the present embodiment operate differently each other, depending on a type of an optical disc, namely, on a thickness of a protective substrate, and therefore, operations for an optical disc having the first protective substrate thickness PL1 and operations for an optical disc having the second protective substrate thickness PL2 will be explained in detail respectively, as follows.

First, operations of optical pickup apparatus 1 for BD, namely, for an optical disc having the first protective substrate thickness PL1 will be explained.

In the case of recording of information for an optical disc having the first protective substrate thickness PL1, and in the case of reproducing information recorded on an optical disc having the first protective substrate thickness PL1, light is emitted from blue semiconductor laser LD. Emitted light is reflected by splitter PS and is converted into a parallel light by collimator CL. Then, the parallel light is transmitted through relay lens group REL, liquid crystal shutter LQS, quarter wavelength plate QWP and objective lens OL (ray of light LA1), to form a light-convergent spot on recording surface RL1 of the optical disc having the first protective substrate thickness PL1. In this case, a distance between the first lens group L1 and the second lens group L2 both constituting the relay lens group REL is optimized by uniaxial actuator AC2, thus, the relay lens group emits a parallel light flux.

Light that forms the light-convergent spot is modulated by information pits on recording surface RL1 of the optical disc having the first protective substrate thickness PL1, and it is reflected by the recording surface RL1. This reflected light is transmitted through the objective lens OL, quarter wavelength plate QWP, liquid crystal shutter LQS, relay lens group REL and splitter PS, and is further transmitted through sensor lens SEN to be given astigmatism, and is received by photodetector PD. After this, operations of this kind are repeated, and operations of recording information for the optical disc having the first protective substrate thickness PL1 and operations of reproducing information recorded on the optical disc having the first protective substrate thickness PL1 are completed.

Next, operations of the optical pickup apparatus PU1 for HD, namely, for the optical disc having the second protective substrate thickness PL2 will be explained.

In the case of recording of information for an optical disc having the second protective substrate thickness PL2, and in the case of reproducing information recorded on an optical disc having the second protective substrate thickness PL2, light is emitted from blue semiconductor laser LD. Emitted light is reflected by splitter PS and is converted into a parallel light by collimator CL. Then, the parallel light is transmitted through relay lens group REL, liquid crystal shutter LQS, quarter wavelength plate QWP and objective lens OL (ray of light LA2), to form a light-convergent spot on recording surface RL2 of the optical disc having the second protective substrate thickness PL2. In this case, a distance between the first lens group L1 and the second lens group L2 both constituting the relay lens group REL is optimized to be smaller than that for operations for BD by uniaxial actuator AC2, thus, the relay lens group emits a divergent light flux.

Light that forms the light-convergent spot is modulated by information pits on recording surface RL2 of the optical disc having the second protective substrate thickness PL2, and it is reflected by the recording surface RL2. This reflected light is transmitted through the objective lens OL, quarter wavelength plate QWP, liquid crystal shutter LQS, relay lens group REL and splitter PS, and is further transmitted through sensor lens SEN, to be given astigmatism, and is received by photodetector PD. After this, operations of this kind are repeated, and operations of recording information for the optical disc having the second protective substrate thickness PL2 and operations of reproducing information recorded on the optical disc having the second protective substrate thickness PL2 are completed.

Incidentally, as shown in FIG. 16, it is preferable to substantially equalize entrance pupil diameters for a combination of the relay lens group and the objective lens for both of obtaining necessary numerical apertures NA1 of the objective lens necessary for conducting recording operations for optical discs having the first protective substrate thicknesses, and obtaining necessary numerical apertures NA2 of the objective lens necessary for conducting recording operations for optical discs having the second protective substrate thicknesses.

### EXAMPLE

Next, examples respectively of the optical system and optical pickup apparatus PU1 will be explained.

First, items which are common for each example will be explained. In Examples 1-7, an optical disc (BD) having the first protective substrate thickness PL1 is established to have wavelength λ₁=405 nm, protective substrate thickness t₁=0.1 mm and first numerical aperture NA₁=0.85, while, an optical disc (HD) having the second protective substrate thickness PL2 is established to have wavelength λ₁=405 nm, protective substrate thickness t₂=0.6 mm, second numerical aperture NA₂=0.65, and focal length f of objective lens OL=2.2 mm. Further, in all Examples, when conducting recording and/or reproducing for BD, a parallel light enters an objective lens, and when conducting recording and/or reproducing for HD, a divergent light enters the objective lens.

Therefore, the optical system and optical pickup apparatus PU1 in each of Examples 1-7 satisfy the aforesaid expression (2) of 0.06≦t₁≦0.11 and the aforesaid expression (3) of 0.54≦t₂≦0.62. Further, a value of NA₁·TF₁/(NA₂·TF₂) is 1.0, and it also satisfies the aforesaid expression (9) of 0.95≦NA₁·TF₁/(NA₂·TF₂)≦1.05.

Further, all of lenses each constituting relay lens group REL in each of Examples 1-7 is made of polyolefin-based plastic such as Zeonex (made by Nippon Zeon Co., Ltd.), and water absorption of this polyolefin-based plastic is mostly 0%.

Details of each example will be explained next.

### Example 1

First, Example 1 will be explained.

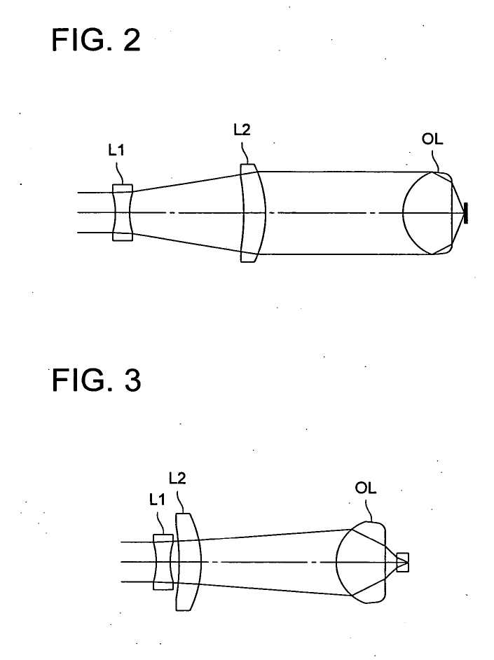

As shown in FIG. 2 and FIG. 3, relay lens group REL in the present example has a two-lens-groups structure including the first lens group having negative refractive power and the second lens group having positive refractive power.

Next, data of each lens in the present example and a spheric surface data are shown respectively in the following Table 1 and Table 2, and a value of dn in optical discs of the first protective substrate thickness PL1 and the second protective substrate thickness PL2 in Table 1 and a value of a diaphragm are shown in Table 3.

TABLE 1

| Surface No. | r(mm) | d(mm) | n(405) | nd |
|---|---|---|---|---|
| OBJ | | ∞ | | |
| 1 | −6.860 | 0.800 | 1.54111 | 1.52510 |
| 2 | 8.827 | d2 | | |
| 3 | −13.114 | 1.200 | 1.54111 | 1.52510 |
| 4 | −5.041 | 7.000 | | |
| 5 | 1.543 | 2.650 | 1.64109 | 1.62299 |
| (Diaphragm) | | | | |
| 6 | −5.418 | d6 | | |
| 7 | ∞ | d7 | 1.62230 | 1.58546 |
| 8 | ∞ | | | |

“OBJ” in the Table in this case shows a position of an object, and the object is positioned to be infinite, because light emitted from semiconductor laser LD is collimated by collimator CL to be a collimated light. Further, symbols in the Table r, d, n (405) and nd respectively show a radius of curvature, a distance between surfaces, refractive index at wavelength 405 nm and refractive index at d line (587 nm). Furthermore, on the surface where characters of “Diaphragm” are described in the column of the Surface No., there is provided an aperture restriction member such as a liquid crystal shutter on a surface of objective lens OL.

TABLE 2

| | First surface | Fourth surface | Fifth surface | Sixth surface |
|---|---|---|---|---|
| K | 0.00000 | 0.00000 | −0.65938 | −143.51926 |
| A4 | 1.5145E−03 | 4.2449E−04 | 7.8662E−03 | 1.1145E−01 |
| A6 | −1.6848E−03 | 2.3289E−05 | 2.9484E−04 | −1.2396E−01 |
| A8 | −1.7244E−04 | −3.0030E−05 | 1.9986E−03 | 8.2423E−02 |
| A10 | 1.8911E−04 | 5.1748E−06 | −1.3258E−03 | −3.9062E−02 |
| A12 | 0.0000E+00 | 0.0000E+00 | 3.0331E−04 | 1.1216E−02 |
| A14 | 0.0000E+00 | 0.0000E+00 | 2.2361E−04 | −1.4257E−03 |
| A16 | 0.0000E+00 | 0.0000E+00 | −1.6968E−04 | 0.0000E+00 |
| A18 | 0.0000E+00 | 0.0000E+00 | 4.4128E−05 | 0.0000E+00 |
| A20 | 0.0000E+00 | 0.0000E+00 | −4.2798E−06 | 0.0000E+00 |

“K” in the Table in this case represents a conic constant and A2I (I represents 2, 3, 4, . . . ) represents a spheric surface coefficient.

Incidentally, with respect to this a spheric surface form, coordinates (x, y, z) of points on the a spheric surface are determined to satisfy the following conditional expressions (12) and (13), under the condition that Z axis is taken in the optical axis direction, and two coordinate axes x axis and y axis which are perpendicular to each other are taken to be perpendicular to the z axis;

$$z = \frac{{h}^{2} / r}{1 + \sqrt{1 - ( 1 + K ) {h}^{2} / {r}^{2}}} + {\sum }_{I} A 2 I \cdot {h}^{21} \qquad ( 12 )$$

where, x (h) represents an axis (direction of advancement of light is positive) in the optical axis direction, K represents conic constant, A2I (I represents 2, 3, 4, . . . ) represents a spheric surface coefficient, h (nm) represents a height in the direction perpendicular to the optical axis and r represents a radius of curvature.
h=\sqrt{x²+y²} (13)

TABLE 3

| | d(mm) |
|---|---|
| d₂ (First type) | 5.898 |
| d₂ (Second type) | 0.400 |
| d₆ (First type) | 0.662 |
| d₆ (Second type) | 0.527 |
| d₇ (First type | 0.100 = t₁ |
| d₇ (Second type) | 0.600 = t₂ |
| Diaphragm (First type) | 3.848 |
| Diaphragm (Second type) | 3.236 |

AS a result, a value of (NA₁·δ)/(t₂−t₁) is 9.4 and it satisfies the aforesaid expressions (1) and (4) of 7.5≦(NA₁·δ)/(t₂−t₁)≦22. Further, a value of p₁/p₂ is −2.05, and it satisfies the aforesaid expression (5) −3.5≦p₁/p₂≦−1.8.

### Example 2

Next, Example 2 will be explained.

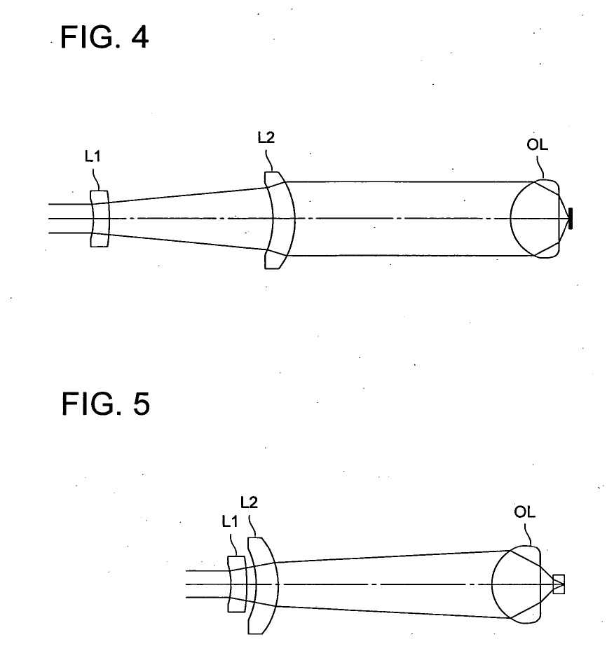

As shown in FIGS. 4 and 5, relay lens group REL in the present example has a two-lens-groups structure including the first lens group having negative refractive power and the second lens group having positive refractive power, in the same way as in Example 1.

Data of each lens in the present example and a spheric surface data are shown respectively in the following Table 4 and Table 5, and a value of dn in optical discs of the first type protective substrate thickness PL1 and the second type protective substrate thickness PL2 in Table 4 and a value of a diaphragm are shown in Table 6.

TABLE 4

| Surface No. | r(mm) | d(mm) | n(405) | nd |
|---|---|---|---|---|
| OBJ | | ∞ | | |
| 1 | −2.500 | 0.800 | 1.54111 | 1.52510 |
| 2 | −11.119 | d2 | | |
| 3 | −4.155 | 1.200 | 1.54111 | 1.52510 |
| 4 | −3.187 | 11.269 | | |
| 5 | 1.543 | 2.650 | 1.64109 | 1.62299 |
| (Diaphragm) | | | | |
| 6 | −5.418 | d6 | | |
| 7 | ∞ | d7 | 1.62230 | 1.58546 |
| 8 | ∞ | | | |

TABLE 5

| | First surface | Fourth surface | Fifth surface | Sixth surface |
|---|---|---|---|---|
| K | 0.00000 | 0.00000 | −0.65938 | −143.51926 |
| A4 | 5.3528E−02 | 2.2616E−03 | 7.8662E−03 | 1.1145E−01 |
| A6 | −2.1103E−01 | −2.5225E−04 | 2.9484E−04 | −1.2396E−01 |
| A8 | 3.8861E−01 | 9.5302E−05 | 1.9986E−03 | 8.2423E−02 |
| A10 | −2.6035E−01 | −5.9814E−06 | −1.3258E−03 | −3.9062E−02 |
| A12 | 0.0000E+00 | 0.0000E+00 | 3.0331E−04 | 1.1216E−02 |
| A14 | 0.0000E+00 | 0.0000E+00 | 2.2361E−04 | −1.4257E−03 |
| A16 | 0.0000E+00 | 0.0000E+00 | −1.6968E−04 | 0.0000E+00 |
| A18 | 0.0000E+00 | 0.0000E+00 | 4.4128E−05 | 0.0000E+00 |
| A20 | 0.0000E+00 | 0.0000E+00 | −4.2798E−06 | 0.0000E+00 |

TABLE 6

| | d(mm) |
|---|---|
| d₂ (First type) | 8.400 |
| d₂ (Second type) | 0.400 |
| d₆ (First type) | 0.662 |
| d₆ (Second type) | 0.518 |
| d₇ (First type | 0.100 = t₁ |
| d₇ (Second type) | 0.600 = t₂ |
| Diaphragm (First type) | 3.848 |
| Diaphragm (Second type) | 3.236 |

AS a result, a value of (NA₁·δ)/(t₂−t₁) is 13.6 and it satisfies the aforesaid expressions (1) and (4) of 7.5≦(NA₁·δ)/(t₂−t₁)≦22.

Further, a value of p₁/p₂ is −2.86, and it satisfies the aforesaid expression (5) −3.5≦p₁/p₂≦−1.8.

### Example 3

Next, Example 3 will be explained.

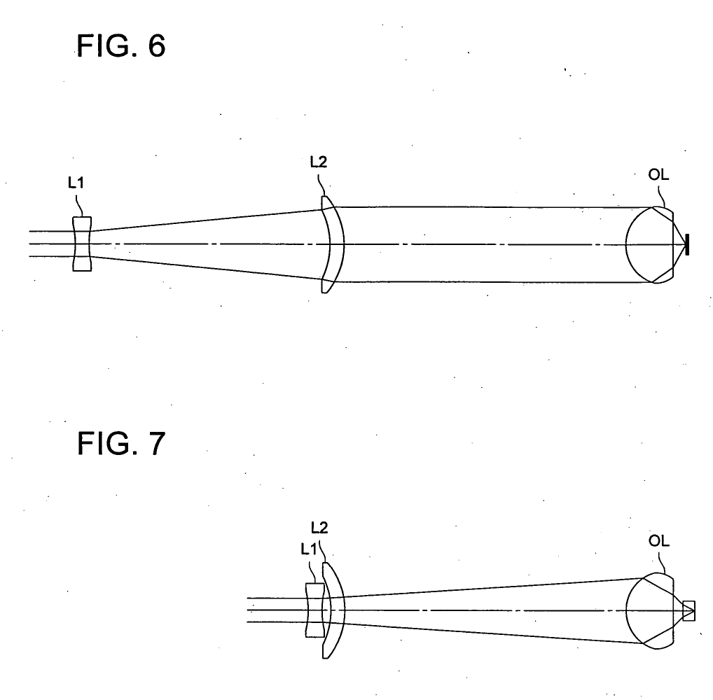

As shown in FIG. 6 and FIG. 7, relay lens group REL in the present example has a two-lens-groups structure including the first lens group having negative refractive power and the second lens group having positive refractive power, in the same way as in the First Example and the Second Example.

Data of each lens in the present example and a spheric surface data are shown respectively in the following Table 7 and Table 8, and a value of dn in optical discs of the first type protective substrate thickness PL1 and the second type protective substrate thickness PL2 in Table 7 and a value of a diaphragm are shown in Table 9.

TABLE 7

| Surface No. | r(mm) | d(mm) | n(405) | nd |
|---|---|---|---|---|
| OBJ | | ∞ | | |
| 1 | −10.287 | 0.800 | 1.54111 | 1.52510 |
| 2 | 6.469 | d2 | | |
| 3 | −4.286 | 0.776 | 1.54111 | 1.52510 |
| 4 | −3.335 | 14.806 | | |
| 5 | 1.543 | 2.650 | 1.64109 | 1.62299 |
| (Diaphragm) | | | | |
| 6 | −5.418 | d6 | | |
| 7 | ∞ | d7 | 1.62230 | 1.58546 |
| 8 | ∞ | | | |

TABLE 8

| | First surface | Fourth surface | Fifth surface | Sixth surface |
|---|---|---|---|---|
| K | 0.00000 | 0.00000 | −0.65938 | −143.51926 |
| A4 | 4.6594E−02 | 1.9011E−03 | 7.8662E−03 | 1.1145E−01 |
| A6 | −2.0818E−01 | −2.5864E−04 | 2.9484E−04 | −1.2396E−01 |
| A8 | 3.9834E−01 | 8.8118E−05 | 1.9986E−03 | 8.2423E−02 |
| A10 | −2.7747E−01 | −6.2397E−06 | −1.3258E−03 | −3.9062E−02 |
| A12 | 0.0000E+00 | 0.0000E+00 | 3.0331E−04 | 1.1216E−02 |
| A14 | 0.0000E+00 | 0.0000E+00 | 2.2361E−04 | −1.4257E−03 |
| A16 | 0.0000E+00 | 0.0000E+00 | −1.6968E−04 | 0.0000E+00 |
| A18 | 0.0000E+00 | 0.0000E+00 | 4.4128E−05 | 0.0000E+00 |
| A20 | 0.0000E+00 | 0.0000E+00 | −4.2798E−06 | 0.0000E+00 |

TABLE 9

| | d(mm) |
|---|---|
| d₂ (First type) | 12.400 |
| d₂ (Second type) | 0.400 |
| d₆ (First type) | 0.662 |
| d₆ (Second type) | 0.518 |
| d₇ (First type | 0.100 = t₁ |
| d₇ (Second type) | 0.600 = t₂ |
| Diaphragm (First type) | 3.848 |
| Diaphragm (Second type) | 3.236 |

AS a result, a value of (NA₁·δ)/(t₂−t₁) is 20.4 and it satisfies the aforesaid expressions (1) and (4) of 7.5≦(NA₁·δ)/(t₂−t₁)≦22. Further, a value of p₁/p₂ is −3.0, and it satisfies the aforesaid expression (5) −3.5≦p₁/p₂≦−1.0.

### Example 4

Next, Example 4 will be explained.

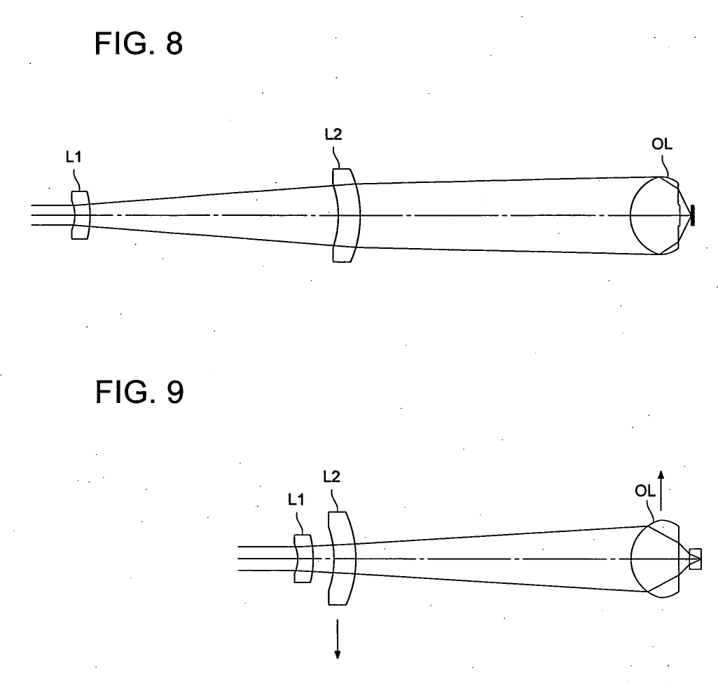

As shown in FIGS. 8 and 9, relay lens group REL in the present example has a two-lens-groups structure including the first lens group having negative refractive power and the second lens group having positive refractive power, in the say way as in Example 1, Example 2 and Example 3. Further, the optical system in the present example is constructed to correct coma of tracking by moving the second lens group in accordance with tracking of the objective lens, when conducting recording on an optical disc having the second type protective substrate thickness PL2.

Data of each lens in the present example and a spheric surface data are shown respectively in the following Table 10 and Table 11, and a value of dn in optical discs of the first type protective substrate thickness PL1 and the second type protective substrate thickness PL2 in Table 10 and a value of a diaphragm are shown in Table 12.

TABLE 10

| Surface No. | r(mm) | d(mm) | n(405) | nd |
|---|---|---|---|---|
| OBJ | | ∞ | | |
| 1 | −2.231 | 0.800 | 1.54111 | 1.52510 |
| 2 | −6.338 | d2 | | |
| 3 | −10.856 | 1.200 | 1.54111 | 1.52510 |
| 4 | −5.955 | 14.396 | | |
| Dummy | ∞ | 0.000 | | |
| 6 | ∞ | 0.000 | | |
| (Diaphragm) | | | | |
| 7 | 1.543 | 2.650 | 1.64109 | 1.62299 |
| 8 | −5.418 | d8 | | |
| 9 | ∞ | d9 | 1.62230 | 1.58546 |
| 10 | ∞ | | | |

TABLE 11

| | First surface | Fourth surface | Seventh surface | Eighth surface |
|---|---|---|---|---|
| K | 0.00000 | 0.00000 | −0.65938 | −143.51926 |
| A4 | 3.3200E−03 | −3.8269E−04 | 7.8662E−03 | 1.1145E−01 |
| A6 | 1.8530E−02 | 4.9621E−04 | 2.9484E−04 | −1.2396E−01 |
| A8 | −3.1408E−02 | −1.5973E−04 | 1.9986E−03 | 8.2423E−02 |
| A10 | 2.1968E−02 | 1.8654E−05 | −1.3258E−03 | −3.9062E−02 |
| A12 | 0.0000E+00 | 0.0000E+00 | 3.0331E−04 | 1.1216E−02 |
| A14 | 0.0000E+00 | 0.0000E+00 | 2.2361E−04 | −1.4257E−03 |
| A16 | 0.0000E+00 | 0.0000E+00 | −1.6968E−04 | 0.0000E+00 |
| A18 | 0.0000E+00 | 0.0000E+00 | 4.4128E−05 | 0.0000E+00 |
| A20 | 0.0000E+00 | 0.0000E+00 | −4.2798E−06 | 0.0000E+00 |

TABLE 12

| | d(mm) |
|---|---|
| d₂ (First type) | 13.000 |
| d₂ (Second type) | 1.000 |
| d₈ (First type) | 0.662 |
| d₈ (Second type) | 0.518 |
| d₉ (First type | 0.100 = t₁ |
| d₉ (Second type) | 0.600 = t₂ |
| Diaphragm (First type) | 3.844 |
| Diaphragm (Second type) | 3.048 |

AS a result, a value of (NA₁·δ)/(t₂−t₁) is 20.4 and it satisfies the aforesaid expressions (1) and (4) of 7.5≦(NA₁·δ)/(t₂−t₁)≦22.

Further, a value of p₁/p₂ is −3.29, and it satisfies the aforesaid expression (5) of −3.5≦p₁/p₂≦−1.8

Further, a value of TO/TR is 0.78, and it satisfies the expression (10) of 0.6≦TO/TR≦1.5.

### Example 5

Next, Example 5 will be explained.

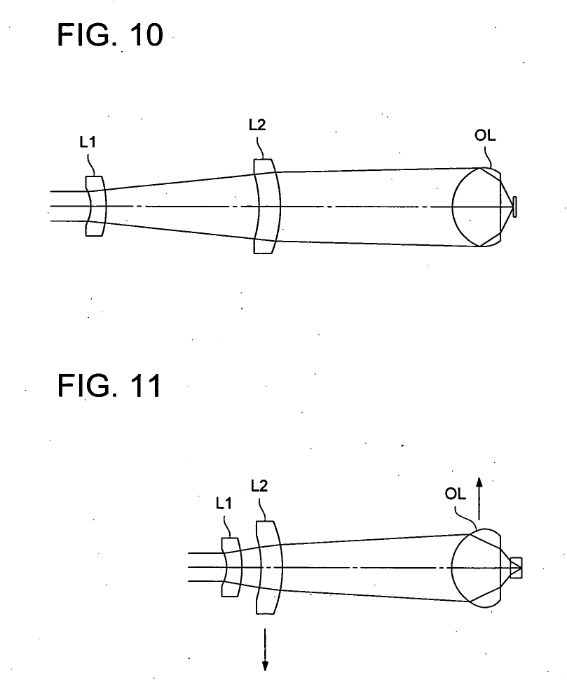

As shown in FIGS. 10 and 11, relay lens group REL in the present example has a two-lens-groups structure including the first lens group having negative refractive power and the second lens group having positive refractive power, in the same way as in Example 1, Example 2, Example 3 and Example 4. Further, the optical system in the present example is constructed to correct coma of tracking by moving the second lens group in accordance with tracking of the objective lens, when conducting recording on an optical disc having the second type protective substrate thickness PL2, in the same way as in Example 4.

Data of each lens in the present example and a spheric surface data are shown respectively in the following Table 13 and Table 14, and a value of dn in optical discs of the first type protective substrate thickness PL1 and the second type protective substrate thickness PL2 in Table 13 and a value of a diaphragm are shown in Table 15.

TABLE 13

| Surface No. | r(mm) | d(mm) | n(405) | nd |
|---|---|---|---|---|
| OBJ | | ∞ | | |
| 1 | −2.196 | 0.800 | 1.54111 | 1.52510 |
| 2 | −6.276 | d2 | | |
| 3 | −8.892 | 1.200 | 1.54111 | 1.52510 |
| 4 | −4.757 | 9.023 | | |
| 5 | ∞ | 0.000 | | |
| 6 | ∞ | 0.000 | | |
| (Diaphragm) | | | | |
| 7 | 1.543 | 2.650 | 1.64109 | 1.62299 |
| 8 | −5.418 | d8 | | |
| 9 | ∞ | d9 | 1.62230 | 1.58546 |
| 10 | ∞ | | | |

TABLE 14

| | First surface | Fourth surface | Seventh surface | Eighth surface |
|---|---|---|---|---|
| K | 0.00000 | 0.00000 | −0.65938 | −143.51926 |
| A4 | 2.5529E−04 | −1.4617E−04 | 7.8662E−03 | 1.1145E−01 |
| A6 | 1.6027E−02 | 5.0350E−04 | 2.9484E−04 | −1.2396E−01 |
| A8 | −1.4261E−02 | −1.5680E−04 | 1.9986E−03 | 8.2423E−02 |
| A10 | 5.7139E−03 | 1.8651E−05 | −1.3258E−03 | −3.9062E−02 |
| A12 | 0.0000E+00 | 0.0000E+00 | 3.0331E−04 | 1.1216E−02 |
| A14 | 0.0000E+00 | 0.0000E+00 | 2.2361E−04 | −1.4257E−03 |
| A16 | 0.0000E+00 | 0.0000E+00 | −1.6968E−04 | 0.0000E+00 |
| A18 | 0.0000E+00 | 0.0000E+00 | 4.4128E−05 | 0.0000E+00 |
| A20 | 0.0000E+00 | 0.0000E+00 | −4.2798E−06 | 0.0000E+00 |

TABLE 15

| | d(mm) |
|---|---|
| d₂ (First type) | 8.000 |
| d₂ (Second type) | 1.000 |
| d₈ (First type) | 0.662 |
| d₈ (Second type) | 0.518 |
| d₉ (First type | 0.100 = t₁ |
| d₉ (Second type) | 0.600 = t₂ |
| Diaphragm (First type) | 3.844 |
| Diaphragm (Second type) | 3.074 |

AS a result, a value of (NA₁·δ)/(t₂−t₁) is 11.9 and it satisfies the aforesaid expressions (1) and (4) of 7.5≦(NA₁·δ)/(t₂−t₁)≦22. Further, a value of p₁/p₂ is −2.56, and it satisfies the aforesaid expression (5) of −3.5≦p₁/p₂≦−1.8

Further, a value of TO/TR is 1.33, and it satisfies the expression (10) of 0.6≦TO/TR≦1.5.

### Example 6

Next, Example 6 will be explained.

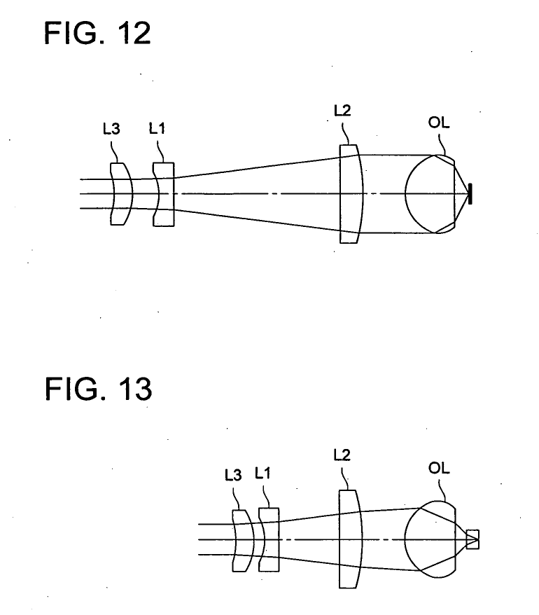

As shown in FIGS. 12 and 13, relay lens group REL in the present example has a three-lens-groups structure including the second lens group L1 having negative refractive power, the third lens group L2 having positive refractive power and the first lens group L3 having positive refractive power.

Data of each lens in the present example and a spheric surface data are shown respectively in the following Table 16 and Table 17, and a value of dn in optical discs of the first type protective substrate thickness PL1 and the second type protective substrate thickness PL2 in Table 16 and a value of a diaphragm are shown in Table 18.

TABLE 16

| Surface No. | r(mm) | d(mm) | n(405) | nd |
|---|---|---|---|---|
| OBJ | | ∞ | | |
| 1 | −4.260 | 1.000 | 1.54111 | 1.52510 |
| 2 | −2.754 | d2 | | |
| 3 | −2.143 | 0.800 | 1.54111 | 1.52510 |
| 4 | −226.664 | d4 | | |
| 5 | −142.218 | 1.200 | | |
| 6 | −8.456 | 2.109 | | |
| 7 | ∞ | 0.000 | | |
| (Diaphragm) | | | | |
| 8 | 1.543 | 2.650 | 1.64109 | 1.62299 |
| 9 | −5.418 | d9 | | |
| 10 | ∞ | d10 | 1.62230 | 1.58546 |
| 11 | ∞ | | | |

TABLE 17

| | First surface | Third surface | Sixth surface | Eighth surface | Ninth surface |
|---|---|---|---|---|---|
| K | 0.00000 | 0.00000 | 0.00000 | −0.65938 | −143.51926 |
| A4 | −2.9941E−03 | 7.1828E−03 | 9.9837E−05 | 7.8662E−03 | 1.1145E−01 |
| A6 | 1.2394E−03 | 4.6841E−03 | 1.6709E−06 | 2.9484E−04 | −1.2396E−01 |
| A8 | 3.7069E−03 | −1.6675E−02 | 6.0459E−06 | 1.9986E−03 | 8.2423E−02 |
| A10 | −7.5999E−03 | 2.0868E−02 | −1.0624E−06 | −1.3258E−03 | −3.9062E−02 |
| A12 | 0.0000E+00 | 0.0000E+00 | 0.0000E+00 | 3.0331E−04 | 1.1216E−02 |
| A14 | 0.0000E+00 | 0.0000E+00 | 0.0000E+00 | 2.2361E−04 | −1.4257E−03 |
| A16 | 0.0000E+00 | 0.0000E+00 | 0.0000E+00 | −1.6968E−04 | 0.0000E+00 |
| A18 | 0.0000E+00 | 0.0000E+00 | 0.0000E+00 | 4.4128E−05 | 0.0000E+00 |
| A20 | 0.0000E+00 | 0.0000E+00 | 0.0000E+00 | −4.2798E−06 | 0.0000E+00 |

TABLE 18

| | d(mm) |
|---|---|
| d₂ (First type) | 1.443 |
| d₂ (Second type) | 0.500 |
| d₄ (First type) | 8.973 |
| d₄ (Second type) | 3.473 |
| d₉ (First type) | 0.662 |
| d₉ (Second type) | 0.509 |
| d₁₀ (First type | 0.100 = t₁ |
| d₁₀ (Second type) | 0.600 = t₂ |
| Diaphragm (First type) | 3.850 |
| Diaphragm (Second type) | 2.986 |

AS a result, a value of (NA₁·δ)/(t₂−t₁) is 9.35 and it satisfies the aforesaid expressions (1) of 7.5≦(NA₁·δ)/(t₂−t₁)≦22 and (6) of 8≦(NA₁·δ)/(t₂−t₁)≦15.

Further, values of p₁/p₃ and p₂/p₃ are respectively 1.42 and −4.14, and they satisfy respectively the expression (7) of −0.7≦p₁/p₃≦1.6 and the expression (8) of −5≦p₂/p₃≦−3.7.

### Example 7

Next, Example 7 will be explained.

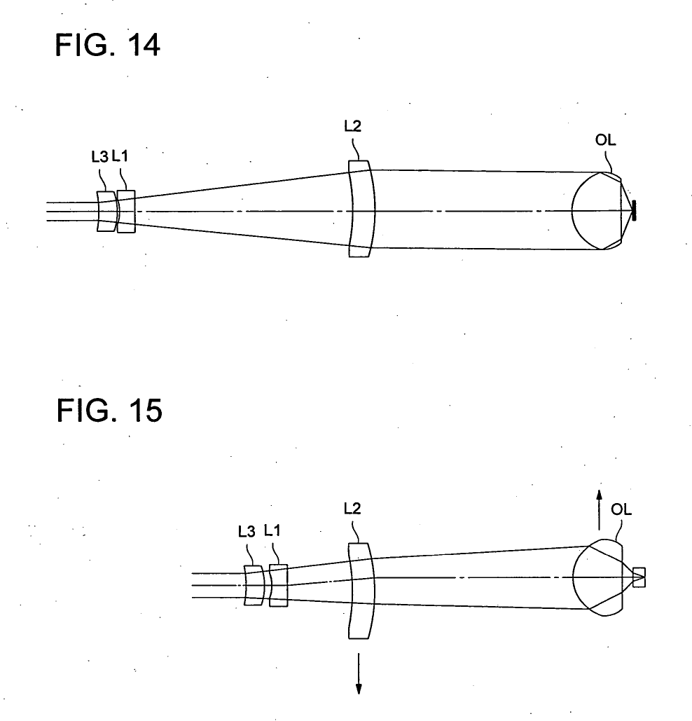

As shown in FIGS. 14 and 15, relay lens group REL in the present example has a three-lens-groups structure including the second lens group L1 having negative refractive power, third lens group L2 having positive refractive power and the first lens group L3 having positive refractive power. Further, the optical system in the present example and optical pickup apparatus PU1 are constructed so that coma relating to tracking operations may be corrected by moving third lens group L3 in accordance with tracking of the objective lens operations, in the case of conducting recording operations for an optical disc having the second type protective substrate thickness PL2.

Data of each lens in the present example and a spheric surface data are shown respectively in the following Table 19 and Table 20, and a value of dn in optical discs of the first type protective substrate thickness PL1 and the second type protective substrate thickness PL2 in Table 19 and a value of a diaphragm are shown in Table 21.

TABLE 19

| Surface No. | r(mm) | d(mm) | n(405) | nd |
|---|---|---|---|---|
| OBJ | | ∞ | | |
| 1 | −4.205 | 1.000 | 1.54111 | 1.52510 |
| 2 | −3.349 | d2 | | |
| 3 | −2.143 | 0.800 | 1.54111 | 1.52510 |
| 4 | −66.815 | d4 | | |
| 5 | −22.109 | 1.200 | | |
| 6 | −6.901 | 10.388 | | |
| Dummy | ∞ | 0.000 | | |
| 8 | ∞ | 0.000 | | |
| (Diaphragm) | | | | |
| 9 | 1.543 | 2.650 | 1.64109 | 1.62299 |
| 10 | −5.418 | d10 | | |
| 11 | ∞ | d11 | 1.62230 | 1.58546 |
| 12 | ∞ | | | |

TABLE 20

| | First surface | Third surface | Sixth surface | Ninth surface | Tenth surface |
|---|---|---|---|---|---|
| K | 0.00000 | 0.00000 | 0.00000 | −0.65938 | −143.51926 |
| A4 | −2.2946E−02 | 2.0767E−02 | 5.9491E−05 | 7.8662E−03 | 1.1145E−01 |
| A6 | 1.4909E−01 | −9.4908E−02 | 2.4805E−05 | 2.9484E−04 | −1.2396E−01 |
| A8 | −1.5626E−01 | 1.4794E−01 | 2.0026E−06 | 1.9986E−03 | 8.2423E−02 |
| A10 | −2.7997E−01 | 5.8696E−02 | −5.9062E−07 | −1.3258E−03 | −3.9062E−02 |
| A12 | 0.0000E+00 | 0.0000E+00 | 0.0000E+00 | 3.0331E−04 | 1.1216E−02 |
| A14 | 0.0000E+00 | 0.0000E+00 | 0.0000E+00 | 2.2361E−04 | −1.4257E−03 |
| A16 | 0.0000E+00 | 0.0000E+00 | 0.0000E+00 | −1.6968E−04 | 0.0000E+00 |
| A18 | 0.0000E+00 | 0.0000E+00 | 0.0000E+00 | 4.4128E−05 | 0.0000E+00 |
| A20 | 0.0000E+00 | 0.0000E+00 | 0.0000E+00 | −4.2798E−06 | 0.0000E+00 |

TABLE 21

| | d(mm) |
|---|---|
| d₂ (First type) | 0.102 |
| d₂ (Second type) | 0.500 |
| d₄ (First type) | 11.381 |
| d₄ (Second type) | 3.381 |
| d₁₀ (First type) | 0.662 |
| d₁₀ (Second type) | 0.511 |
| d₁₁ (First type | 0.100 = t₁ |
| d₁₁ (Second type) | 0.600 = t₂ |
| Diaphragm (First type) | 3.828 |
| Diaphragm (Second type) | 3.046 |

As a result, a value of (NA₁·δ)/(t₂−t₁) is 13.6 and it satisfies the aforesaid expressions (1) of 7.5≦(NA₁·δ)/(t₂−t₁)≦22 and (6) of 8≦(NA₁·δ)/(t₂−t₁)≦15.

Further, values of p₁/p₃ and p₂/p₃ are respectively 0.84 and −4.39, and they satisfy respectively the expression (7) of −0.7≦p₁/p₃≦−1.6 and the expression (8) of −5≦p₂/p₃≦−3.7.

Further, a value of TO/TR is 1.15, and it satisfies the expression (10) of 0.6≦TO/TR≦1.5.

In the optical system and optical pickup apparatus PU1 in the present embodiment, when objective lens OL for which spherical aberration is corrected under the condition that a light flux that is substantially parallel with the objective lens OL or is slightly converged is used for BD having the first type protective substrate thickness PL1, it is possible to correct spherical aberration generated on HD having the second type protective substrate thickness PL by changing a working magnification of the objective lens OL so that a divergent light may enter the objective lens, by moving at least one lens group of the relay lens group REL.

In that case, when the lower limit value of the aforesaid conditional expression (1) is kept, aberration generated when relay lens group REL is decentered can be reduced, and an excellent spot can be generated on the recording surface, thereby, at least one of the excellent recording signal and reproducing signal can be obtained. Further, since an amount of movement of each of uniaxial actuators AC2 and AC3 is proportional to a decentering precision in general, it is possible to prevent an excessive amount of movement of a movable lens, by keeping the upper limit value of the conditional expression (1) not to be exceeded, and thereby, a load applied on each of uniaxial actuators AC2 and AC3 is reduced, which makes it possible to reduce an amount of decentering caused by movement, and to realizing downsizing of optical pickup apparatus PU1.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An optical system for use in an optical pickup apparatus which conducts reproducing and/or recording information for a first optical disk comprising a first protective substrate whose thickness is t1 and a second optical disk comprising a second protective substrate whose thickness is t2 (t1<t2) by using a light flux, the optical system comprising:
(a) a relay lens group comprising:
a plurality of lens groups comprising at least one movable lens group which is movable in the direction of an optical axis, and
(b) an objective lens which converges the light flux emitted from the light source and passing through the relay lens group onto an information recording plane of the first optical disk or the second optical disk, and
wherein in case that the reproducing and/or recording information for the first optical disk is conducted, a light flux emitted from the relay lens group enters the objective lens so that a magnification of the objective lens is more than − 1/100 and less than 1/50,
wherein in case that the reproducing and/or recording information for the second optical disk is conducted, a light flux emitted from the relay lens group enters the objective lens as a divergent light, and
wherein at least one movable lens group satisfies the following formula:
7.5<=(NA1·δ)/(t₂−t₁)<=22,
where NA1 represents a numerical aperture of the objective lens necessary for reproducing and/or recording information for the first optical disk, and δ represents a moving distance between a position of the movable lens group for reproducing and/or recording information for the first optical disk and a position of the movable lens group for reproducing and/or recording information for the second optical disk.

2. The optical system of claim 1, wherein t1 and t2 satisfy the following formulas:
0.06 [mm]<=t1<=0.11 [mm]
0.54 [mm]←t2<=0.62 [mm]

3. The optical system of claim 1, wherein the relay lens group comprises the plurality of lens groups which consists of a second lens group being positive and a first lens group being negative in the order from the objective lens side, and
wherein the first lens group is the movable lens group.

4. The optical system of claim 3, wherein the first lens group consists of a single negative lens, and
wherein the relay lens group satisfies the following formula:
−3.5<=p1/p2<=−1.8
where p1 represents refractive power of the first lens group, and p2 represents refractive power of the second lens group.

5. The optical system of claim 3, wherein the second lens group consists of a single lens comprising a first optical surface on the side of the first lens group and a second optical surface on the side of the objective lens, and
wherein the second optical surface is a convex surface.

6. The optical system of claim 3, wherein NA1 is more than 0.8, and
wherein the relay lens group comprises at least one lens, made of plastic whose water absorption is not more than 0.1%.

7. The optical system of claim 6, wherein the second lens group consists of a single lens made of plastic whose water absorption is not more than 0.1%.

8. The optical system of claim 7, wherein the second lens group is movable in a direction perpendicular to the optical axis.

9. The optical system of claim 1, wherein the relay lens group comprises the plurality of lens groups which consists of a third lens group being positive, a second lens group being negative and a first lens group being positive in the order from the objective lens side, and
wherein the first lens group and the second lens group are the movable lens groups.

10. The optical system of claim 9, wherein the second lens group as the movable lens group satisfies the following formula:
8←(NA1·δ)/(t₂−t₁)<=15,
where δ represents a moving distance between a position of the second lens group for reproducing and/or recording information for the first optical disk and a position of the second lens group for reproducing and/or recording information for the second optical disk.

11. The optical system of claim 10, wherein the relay lens group satisfies the following formulas:
0.7<=p1/p3<=1.6,
−5<=p2/p3<=−3.7,
where p1 represents refractive power of the first lens group, p2 represents refractive power of the second lens group and p3 represents refractive power of the third lens group.

12. The optical system of claim 9, wherein the third lens group consists of a single lens comprising a first optical surface on the side of the second lens group and a second optical surface on the side of the objective lens, and
wherein the second optical surface is a convex surface.

13. The optical system of claim 9,.wherein the second lens group consists of a single lens comprising a first optical surface on the side of the first lens group and a second optical surface on the side of the third lens group, and
wherein the second optical surface is a concave surface.

14. The optical system of claim 9, wherein NA1 is more than 0.8, and
wherein the relay lens group comprises at least one lens made of plastic whose water absorption is not more than 0.1%.

15. The optical system of claim 14, wherein the third lens group consists of a single lens made of plastic whose water absorption is not more than 0.1%.

16. The optical system of 1, wherein the following formula is satisfied:
0.95<=(NA1·TF1)/(NA2·TF2)<=1.05
where TF1 represents a combined focal length of the relay lens group and the objective lens for reproducing and/or recording information for the first optical disk, TF2 represents a combined focal length of the relay lens group and the objective lens for reproducing and/or recording information for the second optical disk, and NA2 represents a numerical aperture of the objective lens necessary for reproducing and/or recording information for the second optical disk.

17. The optical system of claim 1, wherein in case that the divergent light or the convergent light emitted from the relay lens group enters the objective lens, a lens group which is among the lens groups of the relay lens group and is closest to the objective lens is movable in the direction perpendicular to the optical axis and in the direction opposite to the direction of a movement of the objective lens.

18. The optical system of claim 1, wherein in case that the reproducing and/or recording information for the first optical disk is conducted, a substantial parallel light flux emitted from the relay lens group enters the objective lens, and
wherein in case that the reproducing and/or recording information for the second optical disk is conducted, a divergent light flux emitted from the relay lens enters the objective lens and a lens group which is among the lens groups of the relay lens group and is closest to the objective lens is movable perpendicular in the direction perpendicular to the optical axis and in the direction opposite to the direction of a movement of the objective lens.

19. The optical system of claim 1, wherein the following formula is satisfied:
0.6<=TO/TR<=1.5,
where TO represents an absolute value of moving distance of the objective lens moving perpendicular to the optical axis for tracking, and TR represents an absolute value of moving distance of at least one lens group of the relay lens moving perpendicular to the optical axis for tracking.

20. The optical system of claim 17, wherein a lens group which is closest to the objective lens and is among the lens groups of the relay lens group consists of a single lens made of plastic whose water absorption is not more than 0.1% and whose specific gravity is not more than 1.5.

21. The optical system of claim 1, wherein the objective lens consists of two lenses.

22. The optical system of claim 21, wherein a lens which is one of the two lenses of the objective lens and is closer to the relay lens comprises a phase structure.

23. The optical system of claim 21, wherein the following formula is satisfied:
0.05<=PO1/PO2<=0.2
where PO1 represents refractive power of a lens which is one of the two lenses of the objective lens and is closer to the relay lens, and PO2 represents refractive power of a lens which is the other lens of the objective lens and is further to the relay lens.

24. The optical system of claim 1, wherein the optical system further comprises a collimator lens, and
wherein the collimator lens is located in the optical path of the light flux and located further from the objective lens than the relay lens group.

25. The optical system of claim 1, wherein the optical pickup apparatus conducts reproducing and/or recording information for the first optical disk and the second optical disk by using the same light flux.

26. The optical system of claim 1, wherein the optical pickup apparatus conducts reproducing and/or recording information for the first optical disk and the second optical disk by using the different light fluxes having different wavelength.

27. The optical system of claim 1, wherein the following formula is satisfied:
r1·0.8<r2<r1·1.2,
where r1 represents radius of entrance pupil of the relay lens group for reproducing and/or recording information for the first optical disk, and r2 represents radius of entrance pupil of the relay lens group for reproducing and/or recording information for the second optical disk.

28. An optical pickup apparatus for conducting reproducing and/or recording information for a first optical disk comprising a first protective substrate whose thickness is t1 and a second optical disk comprising a second protective substrate whose thickness is t2 (t1<t2) by using a light flux, the optical pickup apparatus comprising:
a light source which emits the light flux, and
a optical system comprising:
(a) a relay lens group comprising:
a plurality of lens groups comprising at least one movable lens group which is movable in the direction of an optical axis, and
(b) an objective lens which converges the light flux emitted from the light source and passing through the relay lens group onto an information recording plane of the first optical disk or the second optical disk, and
wherein in case that the reproducing and/or recording information for the first optical disk is conducted, a light flux emitted from the relay lens group enters the objective lens so that a magnification of the objective lens is more than − 1/100 and less than 1/50,
wherein in case that the reproducing and/or recording information for the second optical disk is conducted, a light flux emitted from the relay lens group enters the objective lens as a divergent light, and
wherein at least one movable lens group satisfies the following formula:
7.5<=(NA1·δ)/(t₂−t₁)<=22,
where NA1 represents a numerical aperture of the objective lens necessary for reproducing and/or recording information for the first optical disk, and δ represents a moving distance between a position of the movable lens group for reproducing and/or recording information for the first optical disk and a position of the movable lens group for reproducing and/or recording information for the second optical disk.

29. An optical disk reproducing and/or recording apparatus, comprising an optical pickup apparatus for conducting reproducing and/or recording information for a first optical disk comprising a first protective substrate whose thickness is t1 and a second optical disk comprising a second protective substrate whose thickness is t2 (t1<t2) by using a light flux, the optical pickup apparatus comprising:
a light source which emits the light flux, and
a optical system comprising:
(a) a relay lens group comprising:
a plurality of lens groups comprising at least one movable lens group which is movable in the direction of an optical axis, and
(b) an objective lens which converges the light flux emitted from the light source and passing through the relay lens group onto an information recording plane of the first optical disk or the second optical disk, and
wherein in case that the reproducing and/or recording information for the first optical disk is conducted, a light flux emitted from the relay lens group enters the objective lens so that a magnification of the objective lens is more than − 1/100 and less than 1/50,
wherein in case that the reproducing and/or recording information for the second optical disk is conducted, a light flux emitted from the relay lens group enters the objective lens as a divergent light, and
wherein at least one movable lens group satisfies the following formula:
7.5<=(NA1·δ)/(t₂−t₁)<=22,
where NA1 represents a numerical aperture of the objective lens necessary for reproducing and/or recording information for the first optical disk, and δ represents a moving distance between a position of the movable lens group for reproducing and/or recording information for the first optical disk and a position of the movable lens group for reproducing and/or recording information for the second optical disk.

30. A relay lens group for use in an optical pickup apparatus which conducts reproducing and/or recording information for a first optical disk comprising a first protective substrate whose thickness is t1 and a second optical disk comprising a second protective substrate whose thickness is t2 (t1<t2) by using a light flux and comprises the relay lens group and the objective lens which converges the light flux emitted from the light source and passing through the relay lens group onto an information recording plane of the first optical disk or the second optical disk, the relay lens group comprising:
a plurality of lens groups comprising at least one movable lens group which is movable in the direction of an optical axis, and
wherein in case that the reproducing and/or recording information for the first optical disk is conducted, a light flux emitted from the relay lens group enters the objective lens so that a magnification of the objective lens is more than − 1/100 and less than 1/50,
wherein in case that the reproducing and/or recording information for the second optical disk is conducted, a light flux emitted from the relay lens group enters the objective lens as a divergent light, and
wherein at least one movable lens group satisfies the following formula:
7.5<=(NA1·δ)/(t₂−t₁)<=22,
where NA1 represents a numerical aperture of the objective lens necessary for reproducing and/or recording information for the first optical disk, and δ represents a moving distance between a position of the movable lens group for reproducing and/or recording information for the first optical disk and a position of the movable lens group information for the second
